(19) United States
(12) Patent Application Publication
(10) Pub. No.: US 2026/0260230 A1
(43) Pub. Date: Sep. 3, 2026

(54) AN IMPROVED SYSTEM AND METHOD FOR PRODUCING AN INTEGRATED DISTRIBUTED LEDGER ECOSYSTEM AND OPERATING PLATFORM

(71) Applicant: Fivancial Inc., Dallas, TX (US)

(72) Inventors: John R. Wingate, Jr., Dallas, TX (US); John J. Reed, Dallas, TX (US); Rebecca A. Reed, Midlothian, TX (US); Michael R. Root, Gig Harbor, WA (US)

(21) Appl. No.: 19/164,995

(22) PCT Filed: Mar. 14, 2024
(86) PCT No.: PCT/US2024/020027

§ 371 Date: Sep. 12, 2025

Related U.S. Application Data
(60) Provisional application No. 63/452,100, filed on Mar. 14, 2023.
(60) Provisional application No. 63/469,915, filed on May 31, 2023.

(51) Int. Cl. G06Q 20/36; G06Q 20/38

(52) U.S. Cl. CPC G06Q 20/367; G06Q 20/389

(57) ABSTRACT

An integrated distributed ledger ecosystem and operating platform conducts online transactions using one or more distributed ledgers. The ecosystem and operating platform uses an AI-powered global identity subsystem, a verification-as-a-service platform, accessed via one or more application programming interfaces (APIs) to verify users of the platform. A credentialing subsystem is used to assess, store and issue identity credentials for verified users. The operating platform provides each user with a digital wallet to interface with the platform. A digital wallet produces a distributed key hashing of one or more assets associated with the user.

### CROSS-REFERENCE TO RELATED APPLICATIONS

This application claims priority to U.S. Provisional 63/469,915, filed May 31, 2023, and U.S. Provisional 63/452,100, filed Mar. 14, 2023, which are hereby incorporated by reference as if submitted in their entirety.

### BACKGROUND

### Field

The present disclosure relates to an integrated distributed ledger ecosystem and, more specifically, an integrated distributed ledger ecosystem and operating platform that provides secure data access using artificial intelligence, machine learning, or combinations thereof.

### Background

A digital wallet is a software application or service that allows users to securely store, manage, and transact with digital currencies, such as Bitcoin or Ethereum. When a user creates a digital wallet, they are provided with a unique address, which is essentially their public key. This address serves as the destination for sending and receiving cryptocurrencies. Additionally, the wallet generates a private key, which is kept secret and is used to sign transactions, providing ownership of the funds associated with the wallet's address.

To make a transaction using a digital wallet, the user initiates a transfer by specifying the recipient's wallet address and the amount of cryptocurrency they wish to send. The wallet then creates a transaction message, which includes the sender's address, the recipient's address, and the amount of cryptocurrency being transferred. This transaction message is signed with the sender's private key to prove ownership and prevent tampering. Once the transaction is created, it is broadcasted to the cryptocurrency network for verification and inclusion in the blockchain.

Upon receiving the transaction, miners on the cryptocurrency network validate it by ensuring that the sender has sufficient funds and that the transaction adheres to the protocol rules. Once validated, the transaction is included in a block and added to the blockchain, a distributed ledger that records all transactions in chronological order. The recipient's digital wallet then reflects the updated balance, and the transaction is considered complete.

Today, crypto scams are prevalent in many forms, primarily associated with websites. The scammers get people to connect their wallets and drain the wallet after it is connected. What is needed in the art is secure processes to prevent users from engaging with false websites while providing a safe and secure platform to conduct online transactions using digital currencies and other digital assets, such as tokenized assets.

### SUMMARY

The present embodiments may relate to, inter alia, systems and methods for providing a distributed ledger ecosystem and operating platform. The disclosed platform integrates multiple components to provide a safe, transactional ecosystem while leveraging distributed ledger (e.g., blockchain) technology. The components may include, for example, identity verification (e.g., KYC/AML), global identity credentialing, transactional cryptocurrency exchange, a flexible digital wallet, and a transaction-enabling stablecoin.

In a first aspect, a method for providing stablecoin settlement disintermediation is provided. The method may be performed by a processor and a memory of a computing device. The method may include, for example, 1) receiving verification of at least one user, 2) issuing an instance of a digital wallet to a digital wallet application on a mobile device associated with the at least one user, 3) receiving a transaction request from the digital wallet application, and 4) completing the transaction request using one or more blockchain networks coupled to the stablecoin settlement disintermediation system.

In a second aspect, method for providing a settlement disintermediation system and mechanism is provided. The method may be performed by a processor and a memory of a computing device. The method may include, for example, 1) receiving verification of at least one user associated with a user device, 2) initializing a digital wallet on the user device, 3) receiving, from the digital wallet, an acquisition request of a digital asset, wherein the digital asset is associated with a settlement disintermediation platform, 4) creating a transaction based on the acquisition request, 5) sending the transaction to a blockchain network to complete the transaction, and in response to the sending, updating the digital wallet based at least in part on information sent to the blockchain network to complete the transaction.

### BRIEF DESCRIPTION OF THE DRAWINGS

For a detailed description of various examples, reference will now be made to the accompanying drawings.

FIG. 1 shows, in block diagram form, a simplified network diagram in accordance with one or more embodiments.

FIG. 2 shows, in block diagram form, a simplified system diagram for an electronic device in accordance with one or more embodiments.

FIG. 3 shows an example architecture similar in form and function to mesh topology coupled with RAID array storage mechanisms in accordance with one or more embodiments.

FIG. 4 shows an example interface between a user and the operating platform in accordance with one or more embodiments.

FIG. 5 shows an example implementation of deterministic and heuristic optimization in accordance with one or more embodiments.

FIG. 6 shows an example mesh liquidity network topology in accordance with one or more embodiments.

FIG. 7 shows an example Cortical Learning AI algorithm model in accordance with one or more embodiments.

FIGS. 8A and 8B shows an example AI/ML model with Sparse Distributed Relationships in accordance with one or more embodiments.

FIG. 9 shows an example flow diagram 900 of a user and document verification system in accordance with one or more embodiments.

FIG. 10 shows an example flow diagram 1000 of a credentialing platform in accordance with one or more embodiments.

FIG. 11 shows an example flow diagram 1100 of a smart contract platform in accordance with one or more embodiments.

FIG. 12 shows an example flow diagram 1200 of transaction monitoring in accordance with one or more embodiments.

FIGS. 13A and 13B show an example flow diagrams 1300A and 1300B of transaction processing in accordance with one or more embodiments.

FIG. 14A shows an example block diagrams 1400A of a stablecoin settlement platform in accordance with one or more embodiments.

FIGS. 14B and 14C show example flow diagrams 1400B and 1400C of a stablecoin settlement platform in accordance with one or more embodiments.

FIG. 15 shows an example flow diagram 1500 of a Fi2Fi embodiment in accordance with one or more embodiments.

FIG. 16 shows an example flow diagram 1600 of a Proof of Reserve embodiment in accordance with one or more embodiments.

FIG. 17 shows an example block diagram 1700 of settlement rail disintermediation in accordance with one or more embodiments.

FIG. 18 shows an example block diagram 1800 of core banking data hashing in accordance with one or more embodiments.

FIGS. 19A-19J illustrate example screenshots of user interfaces displayed of the disclosed Platform in accordance with one or more embodiments.

The Figures depict preferred embodiments for purposes of illustration only. One skilled in the art will readily recognize from the following discussion that alternative embodiments of the systems and methods illustrated herein may be employed without departing from the principles of the embodiments described herein.

### DETAILED DESCRIPTION

The subject matter will now be descried in detail for specific preferred embodiments. It is understood that the described embodiments are intended only as illustrative examples and are not to be limited thereto.

The disclosed technology relates to, inter alia, systems and methods for providing an integrated distributed ledger ecosystem and operating platform. In an exemplary embodiment, the disclosed systems and methods integrate multiple components to provide a safe and secure environment for a transactional ecosystem using distributed ledger technology. Integrated components include, but are not limited to, identity verification, global identity credentialing, transactional cryptocurrency exchange, flexible digital wallet and platform, and a transaction-enabling stablecoin. A range of services may be provided by the integrated ecosystem and platform. For example, a user may be provided with a crypto-driven electronic payment instrument. The electronic payment instrument may, for example, source one or more liquidity pools (e.g., AI-driven liquidity pools). The electronic payment instrument may be provided as a mobile application on the user's mobile device as a digital wallet that connects to a plurality of services within the integrated distributed ledger ecosystem. The digital wallet may interface with one or more decentralized exchanges (DEX) which enables the user to transact crypto-driven purchases. Additionally, or alternatively, the digital wallet may include integrated key recovery services and a transaction-enabling stablecoin. In some cases, the stablecoin may be provided with a guaranteed 1:1 proof of cash reserves.

In some embodiments, the disclosed ecosystem and operating platform may include a process for onboarding a new user to gain access to the ecosystem and operating platform. The onboarding process may include a KYC/AML (Know Your Customer/Anti-Money Laundering) process to verify the new user's identity. Additionally, or alternatively, the onboarding process may include the use of artificial intelligence (AI) security to verify the new user's identity. Further, the onboarding process may include one or more safeguards to detect and prevent fraud. In some embodiments, the new user may be provided with user-managed credit scoring. Upon verification of the new user, the new user may be provided with a global identity credential which grants access to the integrated components of the ecosystem and operating platform described herein.

Reference in this disclosure to “one embodiment” or to “an embodiment” means that a particular feature, structure, or characteristic described in connection with the embodiment is included in at least one embodiment, and multiple references to “one embodiment” or to “an embodiment” should not be understood as necessarily all referring to the same embodiment or to different embodiments.

### Exemplary Computing System for Providing a Distributed Ledger Ecosystem and Platform

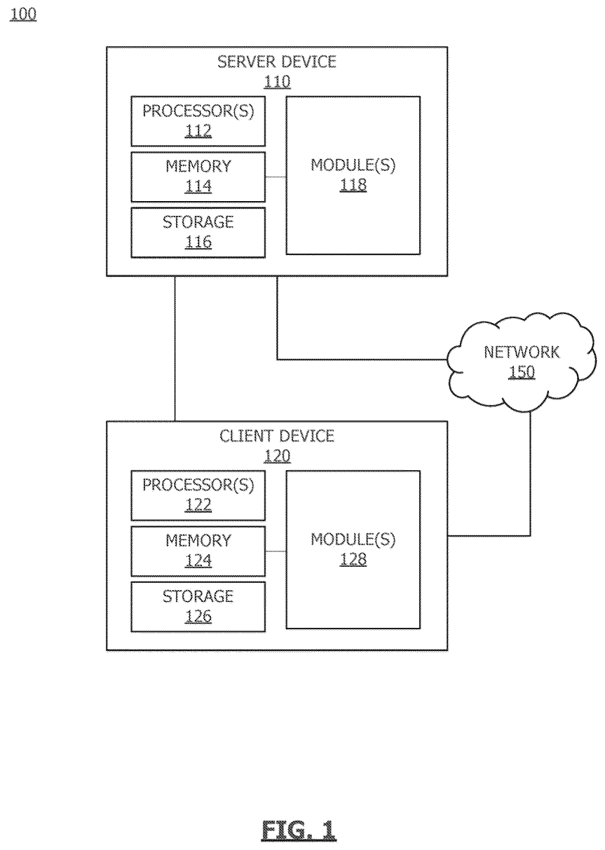

Referring to FIG. 1, a simplified block diagram 100 is depicted of a server device 110 connected to a client device 120 over a network, such as over a network 150. Client device 120 may be a multifunctional device, such as a personal computer, laptop computer, tablet computer, personal digital assistant, mobile device, or the like. In some embodiments, client device 120 may be a wearable device, such as a smartwatch, VR headset, head-mounted device, or the like. A single client device is shown for simplicity. It is understood that multiple client devices may be provided. In some embodiments, a single user may be associated with multiple client devices. In one non-limiting example, a single user may be associated with a personal computer, a mobile device, and a wearable device. Additionally, devices associated with a single user may be compatible with one another and capable of sharing data amongst one another, such as user account data, module data, or the like. Additionally, or alternatively, various components and functionality may be distributed across multiple client devices. Further, additional components may be used and some combination of the functionality of any of the components may be combined.

Server device 110 may include one or more servers or other computing or storage devices on which the various modules and storage devices may be contained. Although server device 110 is depicted as comprising various components in an exemplary manner, in one or more embodiments, the various components and functionality may be distributed across multiple network devices, such as multiple servers, multiple network storage devices, or combinations thereof. Further, additional components may be used and some combination of the functionality of any of the components may be combined. Server device 110 may include one or more processors 112, one or more memory devices 114, and one or more storage devices 116. The one or more processors 112 may include one or more of a central processing unit (CPU), a graphical processing unit (GPU), or the like. Further, processor 112 may include multiple processors of the same or different type. Memory devices 114 may each include one or more different types of memory, which may be used for performing device functions in conjunction with processor 112. For example, memory 114 may include cache, ROM, and/or RAM. Memory 114 may store various programming modules during execution, such as module(s) 118.

Server device 110 may use storage 116 to store, inter alia, media files, media file data, program data, assessment data (e.g., outcome data), AI/ML algorithms, simulation data, or the like. Additional data may include, but is not limited to, neural network training data, DNN configuration data or the like. Storage 116 may include one or more physical storage devices. The physical storage devices may be located within a single location, distributed across multiple storages devices, such as multiple servers, or a combination thereof.

In another embodiment, storage 116 may include model training data for a dataset to train a model. Model training data may include labeled training data that a machine learning model uses to learn and then be enabled to predict and identify neurocognitive deficits. In some embodiments, training data may consist of data pairs of input and output data. For example, input data may include sensory data (e.g., eye-tracking data, hand-eye motor coordination, reaction time, inhibitory control) that been processed along with a corresponding label. The label may be objective or subjective. Additionally, the label may be obtained through detailed experimentation with human users.

Client device 120 may include one or more devices or other computing or storage devices on which the various modules and storage devices may be contained. Client device 120 may be, for example, a personal computer, laptop, tablet PC, head-mounted device, or the like. Although client device 120 is depicted as comprising various components in an exemplary manner, in one or more embodiments, the various components and functionality may be distributed across multiple network devices, such as multiple devices, multiple network storage devices, or combinations thereof. Further, additional components may be used and some combination of the functionality of any of the components may be combined. Client device 120 may include one or more processors 122, one or more memory devices 124, and one or more storage devices 126. The one or more processors 122 may include one or more of a central processing unit (CPU), a graphical processing unit (GPU), or the like. Further, processor 122 may include multiple processors of the same or different type. Memory devices 124 may each include one or more different types of memory, which may be used for performing device functions in conjunction with processor 122. For example, memory 124 may include cache, ROM, and/or RAM. Memory 124 may store various programming modules during execution, including module(s) 128.

Client device 120 may use storage 126 to store, inter alia, media files, media file data, program data, API data, simulation software, AI/ML algorithms, simulation data, or the like. Additional data may include, but is not limited to, neural network training data, DNN configuration data or the like. Storage 126 may include one or more physical storage devices. The physical storage devices may be located within a single location, distributed across multiple storages devices, such as multiple servers, or a combination thereof.

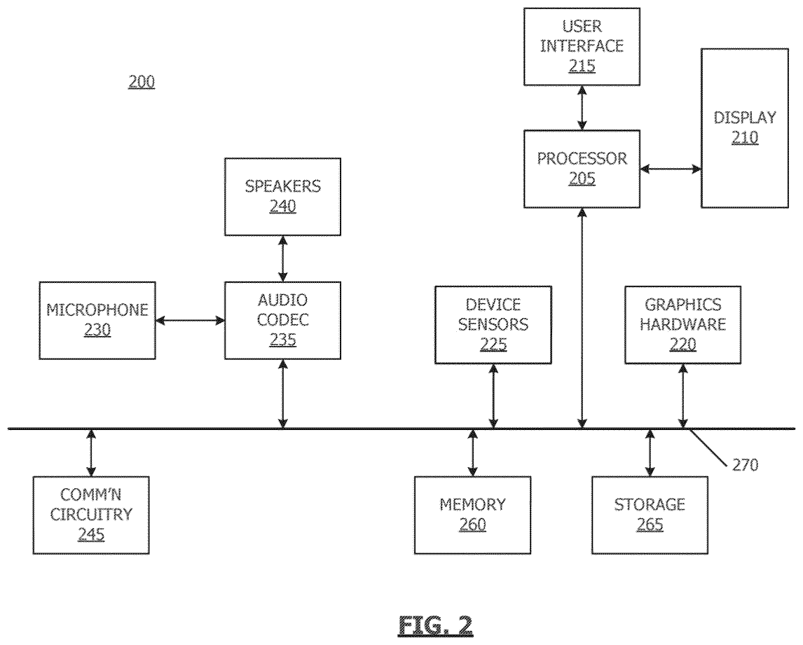

Referring now to FIG. 2, a simplified functional block diagram of illustrative multifunction device 200 is shown according to one embodiment. Multifunctional device 200 may show representative components, for example, for devices of server device 110 or client device 120 of FIG. 1. Multifunction electronic device 200 may include processor 205, display 210, user interface 215, graphics hardware 220, device sensors 225 (e.g., proximity sensor/ambient light sensor, accelerometer and/or gyroscope), microphone 230, audio codec(s) 235, speaker(s) 240, communications circuitry 245, memory 260, storage device 265, and communications bus 270. Multifunction electronic device 200 may be, for example, a digital camera or a personal electronic device such as a personal digital assistant (PDA), personal music player, mobile telephone, a wearable device (e.g., VR headset, smartwatch), a tablet computer, laptop computer, personal computer, or the like.

Processor 205 may execute instructions necessary to conduct or control the operation of many functions performed by device 200. Processor 205 may, for instance, drive display 210 and receive user input from user interface 215. User interface 215 may allow a user to interact with device 200. For example, user interface 215 can take a variety of forms, such as a button, keypad, dial, click wheel, keyboard, display screen, touch screen, or the like. Processor 205 may also, for example, be a system-on-chip such as those found in mobile devices and include a dedicated graphics processing unit (GPU). Processor 205 may be based on reduced instruction-set computer (RISC) or complex instruction-set computer (CISC) architectures or any other suitable architecture and may include one or more processing cores. Graphics hardware 220 may be special purpose computational hardware for processing graphics and/or assisting processor 205 to process graphics information. In one embodiment, graphics hardware 220 may include a programmable GPU.

Memory 260 may include one or more different types of media used by processor 205 and graphics hardware 220 to perform device functions. For example, memory 260 may include memory cache, read-only memory (ROM), and/or random-access memory (RAM). Storage 265 may store media (e.g., audio, image and video files), computer program instructions or software, preference information, device profile information, and any other suitable data. Storage 265 may include one more non-transitory computer-readable storage mediums including, for example, magnetic disks (fixed, floppy, and removable) and tape, optical media such as CD-ROMs and digital video disks (DVDs), and semiconductor memory devices such as Electrically Programmable Read-Only Memory (EPROM), and Electrically Erasable Programmable Read-Only Memory (EEPROM). Memory 260 and storage 265 may be used to tangibly retain computer program instructions or code organized into one or more modules and written in any desired computer programming language. When executed by, for example, processor 205 such computer program code may implement one or more of the methods described herein.

### Financial Instrument—Digital Wallet

In some embodiments, the integrated distributed ledger ecosystem and operating platform (the “Platform”) may provide a user with a crypto-driven electronic payment instrument (the “digital wallet”). The digital wallet may, for example, source one or more liquidity pools (e.g., AI-driven liquidity pools). The digital wallet may be provided as a mobile application on the user's mobile device that connects to a plurality of services within the Platform. The digital wallet may interface with one or more decentralized exchanges (DEX) which enables the user to transact crypto-driven purchases. Additionally, or alternatively, the digital wallet may include integrated key recovery services and a transaction-enabling stablecoin. In some cases, the stablecoin may be provided with a guaranteed 1:1 proof of cash reserves.

In some embodiments, the digital wallet is unique, secure, and user configurable. For example, a user may configure their digital wallet to meet their needs and preferences. Additionally, the digital wallet enables the user to operate efficiently throughout the Platform and other ecosystems. The digital wallet may be provided as a mobile application on the user's mobile device that connects to a plurality of services within the Platform. For example, the digital wallet may be a multiplatform digital application that can reside and operate on a combination of personal devices, such as software module 128 on client device 120 of FIG. 1. The combination of personal devices may have access to the Internet, have Near-Field Communications (NFC) connectivity, or be capable of operating with other communication protocols.

In some embodiments, the digital wallet may use endpoints in unison designed for the transmission and reception of data, content in any type and format (e.g., images, videos, audio clips), the transmission of instructions, and the receipt confirmation that the transmitted instructions were completed. Additionally, the digital wallet may have access to other independent ecosystems (e.g., other financial ecosystems) and is able to operate and interact seamlessly from one ecosystem or platform to another.

In some embodiments, the digital wallet may hold various digital assets (e.g., cryptocurrencies, NFTs). Additionally, or alternatively, the digital wallet may integrate with traditionally paper-based securities (e.g., equity certificates, bearer bonds). Other tokenized assets may be held by the digital wallet as well including, but not limited to, homes, cars, loans, or the like. The digital wallet may, in some cases, convert digital assets to fiat (e.g., cash, stablecoin) as part of a debit transaction. Digital asset conversion may be performed using a combination of centralized and decentralized liquidity pools alongside credit union and/or bank liquidity to satisfy a digital asset's liquidation and funding, either in whole or in part. A point of conversion for a digital asset may be provided at, for example, a point of sale. During the conversion process, the digital wallet may post an API request to a centralized and/or decentralized exchange (CEX/DEX) network via the Platform described herein.

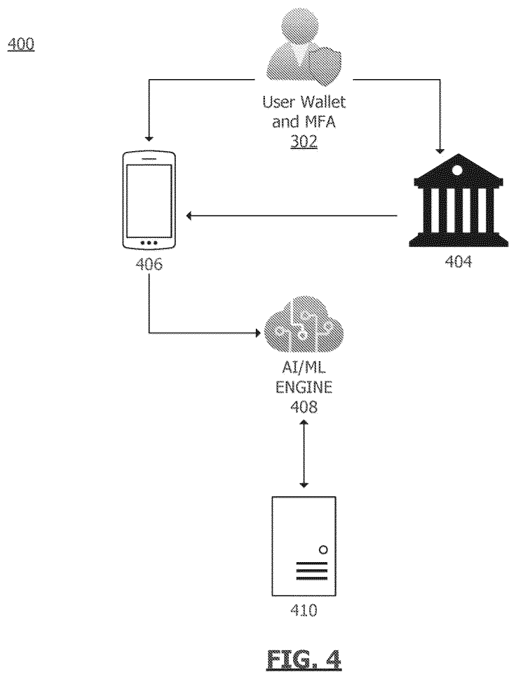

In some embodiments, artificial intelligence (AI) and historical user data may be used to determine the order of asset liquidation. As shown in FIG. 5, a digital wallet 302 may use an AI/ML Engine 408 to determine the order of asset liquidation (e.g., homes 510(a), cars 510(b), crypto 510(c)), whether during a purchase 502 or a sale 506. Additionally, or alternatively, user-defined presets may be used to determine the order of asset liquidation. Once a digital asset is determined to be available for liquidation, the CEX/DEX network can use AI to determine the best liquidity positions to perform liquidation. In some embodiments, a digital asset (e.g., an NFT) may be fractionalized based on the required amount of a transaction. The fractionalized digital asset would be sold on the CEX/DEX network in order of liquidity available, directly into a stablecoin of the network, or another stablecoin which would then be sold into a fiat currency, converted into the network's stablecoin in real-time. Once sale of the digital asset is complete, a merchant or seller may be credited based on their preferred monetary settlement method. For example, a merchant may prefer to receive payments in cryptocurrency (e.g., a stablecoin) or through other settlement layers disintermediation (e.g., PayPal®, Venmo®, Zelle®). Additionally, or alternatively, a merchant may prefer to have payments in cash delivered through a Fi2Fi network.

In one example, a user may be presented with an amount to pay at a point of sale (POS) device during a checkout process. Using their mobile device having a digital wallet stored thereon, such as user wallet 302, the user may tap their device on a tap-to-pay terminal of the POS device to initiate their intent to pay using their digital wallet. Using short-range wireless technology, the user's mobile device securely communicates with the tap-to-pay terminal to exchange information and complete the transaction. User wallet 302 may communicate with AI/ML engine 408 and transmit information received from the tap-to-pay terminal. For example, user wallet 302 may transmit data pertaining to the sale, such as the purchase amount, and user data, identifying information, user preferences, or the like. AI/ML engine 408 would then identify, based on previous user interactions and/or user configuration data, assets available for immediate payment to settle the transaction. For example, if a certain digital asset is available and accepted by the merchant, such as a cryptocurrency 510(c) (e.g., a stablecoin), cash, or another digital asset, the user wallet 302 would then transfer the purchase amount to the merchant to complete the transaction. Additionally, or alternatively, when the user does not have a directly transferable digital asset in their wallet 302, the AI/ML engine 408 may be used to perform a fragmented hash technique to other assets owned by the user, such as homes 510(a), cars 510(b), or the like. In a conversion process, the equity in an asset, such as a home, needing to be converted to dollars would be fractionalized in real time, sold into a liquidity pool of the platform, and converted immediately into an asset accepted by the merchant and transferred to the merchant. In some embodiments, the converted asset may be a stablecoin cryptocurrency that is transferred to a digital wallet associated with the merchant. Users and merchants (e.g., payors and payees) alike may each establish unique parameters to determine the basis on which digital assets held in their digital wallets may be converted. Unique parameters may include, for example, liquidity, current value vs. cost basis, and other rigid criteria, such as a preset last-to-liquidate order.

In another example, during a fiat conversion call, AI/ML engine 408 may assess liquidity parameters set by the user against market conditions and create liquidity by converting digital assets to fiat. Alternatively, AI/ML engine 408 may assess liquidity parameters set by the user against market conditions and create liquidity by converting digital assets to stablecoins and then converting the stablecoins to a fiat currency.

In some embodiments of the disclosed operating platform, a user's digital wallet may uniquely manage various digital assets from ingestion to management to fiat liquidity. For example, a user's digital wallet may be a fully disintermediated application installed on the user's device which enable further embodiments of various digital assets. Further embodiments may include, for example, representations of securities as intelligent contracts, NFTs for carbon credits, and a large variety of similar assets that extend beyond traditional cryptocurrencies. One or more APIs within the user's digital wallet may allow traditional securities firms to deliver securities that are typically defined and restricted to paper, such as equity (i.e. share) certificates and bearer bonds, as digital assets to the user's digital wallet. The one or more APIs within the user's digital wallet may also manage centralized wallet capabilities as well as access to ledgers external to the user's digital wallet. After a user enables fiat conversion of their digital assets, the user's digital wallet may integrate with external contactless payment systems, such as Apple Pay® or Google Pay®, and/or external online payment systems, such as PayPal® or Venmo®, to enable virtual debit card services.

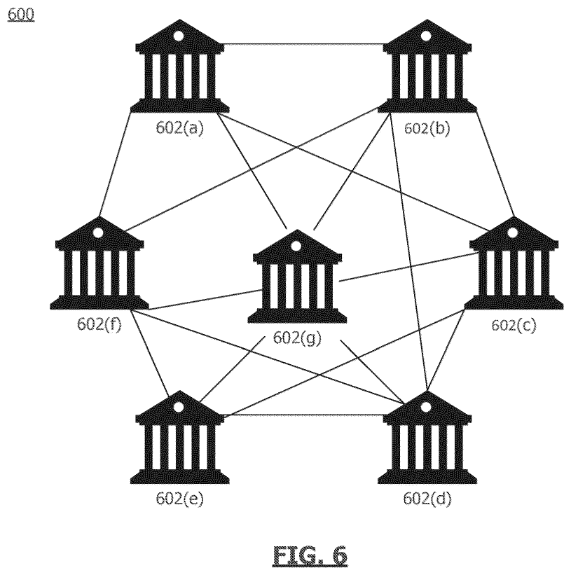

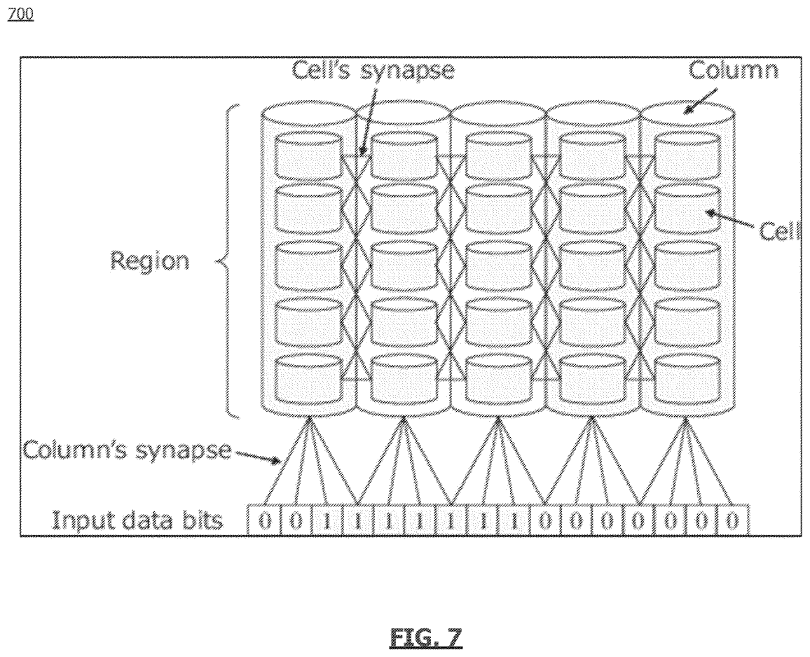

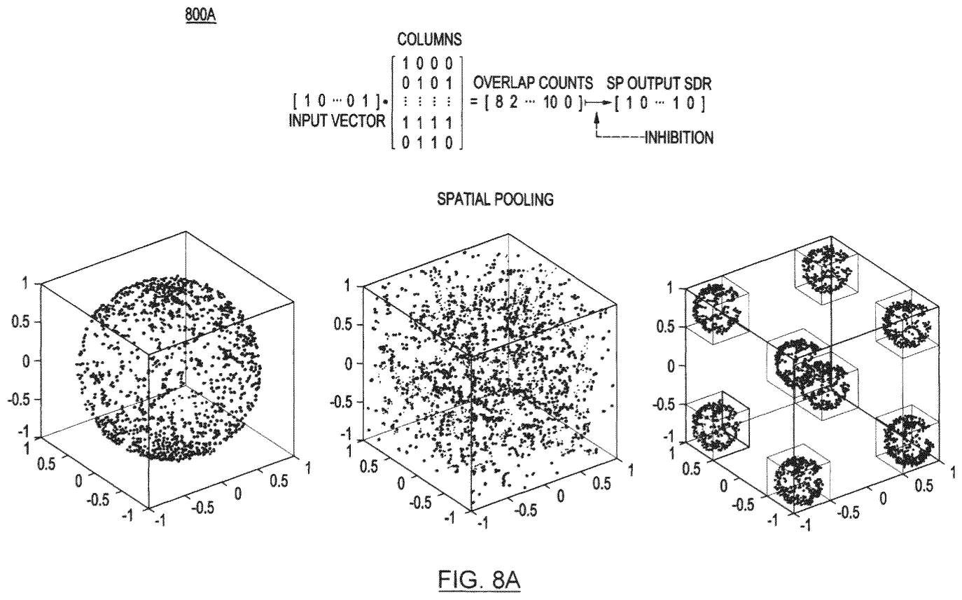

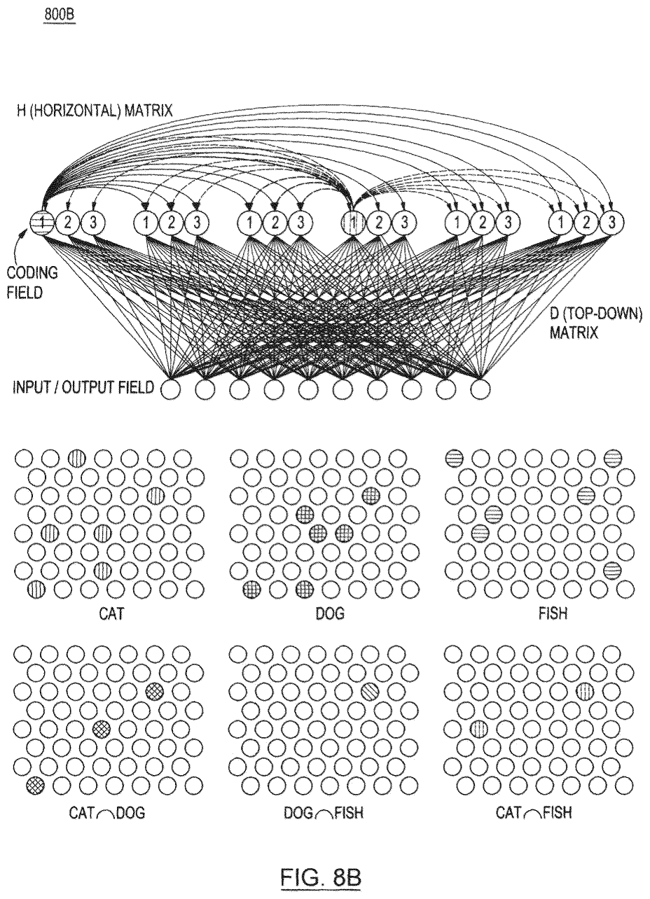

In some embodiments of the disclosed operating platform, the digital wallet may enable users, and institutions, to participate in loans on and collateralized by certain assets, such as cars, businesses and other equities, for example, when tokenized as an NFT, or non-fungible token. In one example, a user may have a list of loans that require funding. The user, via their digital wallet, may use any combination of their digital assets and/or fiat to acquire a position in a loan. During the loan acquisition process, an AI/ML engine, such as AI/ML engine 408, may be used to hold or relinquish positions based on its learning model of user behavior. The AI/ML engine may use a Cortical Learning AI algorithm (CLA) model, illustrated in FIG. 7, or other AI/ML models appropriate for such deterministic heuristics. The AI/ML engine may also use Sparse Distributed Representations (SDRs), illustrated by FIGS. 8A and 8B, or other data modeling techniques for pattern recognition. The AI/ML engine may create user-specific training scenarios based on general market conditions and pricing, the liquidity position of assets, prior use and sale/purchase of assets by the user, user-configured parameters, and other vital attributes.

In an example where the AI/ML engine uses CLA and SDR modeling techniques, once an SDR pattern is identified within an available dataset and the CLA analyzes the patterning, the AI/ML engine can suggest to the user that there is an optimal time to trade a specific asset or set of assets. Additionally, or alternatively, the AI/ML engine may be configured to automatically trade on the user's behalf. In this case, the AI/ML engine may be configured to automatically trade via an API or a direct call within liquidity pools provided by the disclosed operating platform. The automatic trades may be triggered to acquire or liquidate an asset. If the AI/ML engine is configured to notify the user of an optimal trade, the user may be prompted to accept or deny the trade. The user may be notified via a notification on their mobile device by the digital wallet app, by a text message, by an e-mail, or the like. Trades may be performed on behalf of the user, either through an API or via a direct connection, using liquidity pools of the disclosed operating platform.

In some embodiments, the user may take a loan position that has been purchased and stored (e.g., tokenized) on their digital wallet and can fractionalize the loan to resell on a secondary market. For example, the user may package portions of whole or partial loans with other whole or partial loans they hold positions in and liquidate them on a tokenized market for other digital assets or cash. In another example, the user may be given the option to swap loans and digital assets on an open trading market provided by the disclosed operating platform via their digital wallet.

Crypto scams are prevalent in many forms and are primarily associated with websites. Bad actors convince users to connect their crypto wallets (e.g., MetaMask® wallet) to a fraudulent website. Once connected, the bad actors drain the user's wallet of its assets. In an example of the disclosed digital wallet, website protection is provided as an app within the digital wallet to prevent such scenarios. For example, when a user attempts to connect their digital wallet to a website, the user may receive an alert indicating the trustworthiness of the website. The alert may result from, for example, an SSL certificate check that the domain the SSL has been verified through is a valid SSL with proper signing authority. If the website does not have an SSL, the SSL is from a weak signing entity, or a self-signed authority, the user may be notified that they are potentially engaging with a false website, and they should proceed at their own risk. In some embodiments, when the user visits a website using their digital wallet, an internal AI/ML process may be used to confirm that the website has matched specific security metrics. This way, the user can be confident in knowing that they are engaging in business with a reputable entity.

In some embodiments of the disclosed technology, the integrated distributed ledger ecosystem and operating platform may include an AI/ML engine that builds training models. The training models may be built from training datasets, such as:
1. User-suppled feedback on websites the user either does not want to interact with or has had a bad prior experience;
2. SSL certificates from a credentialing system or credentialing authority (e.g., GoDaddy® or Comodo®); and/or
3. Data from other trusted systems and/or reporting authorities about hacks, compromised websites, or the like.
   Other types of training datasets may be used to build training models within the scope of the disclosed embodiments.

The AI/ML engine may use, for example, Cortical Learning Algorithms, like the one illustrated in FIG. 7, or other AI/ML algorithms and heuristics along with Sparse Distributed Representations (SDRs), illustrated by FIGS. 8A and 8B, or other data modeling techniques to create a forward-looking risk score on one or more websites. The forward-looking risk scores may be created for websites being visited by a user. Alternatively, the forward-looking risk scores may be created for websites based on the user's configuration or preferences. In one example implementation, the AI/ML engine may automatically block a website when interaction with a fraudulent website by the user is detected, based at least in part on the forward-looking risk score of the website. Alternatively, the user may be prompted to terminate interaction with a fraudulent website based at least in part on the forward-looking risk score of the website. The AI/ML engine may also look forward to any wallet connecting feature, smart contracts, other digital wallets, or the like and generate risk scores for each. Potentially compromised website data identified by the AI/ML engine may be used to update the forward-looking risk score model by adding to the SDR pattern and CLA recognition of websites that have interacted with known bad actors.

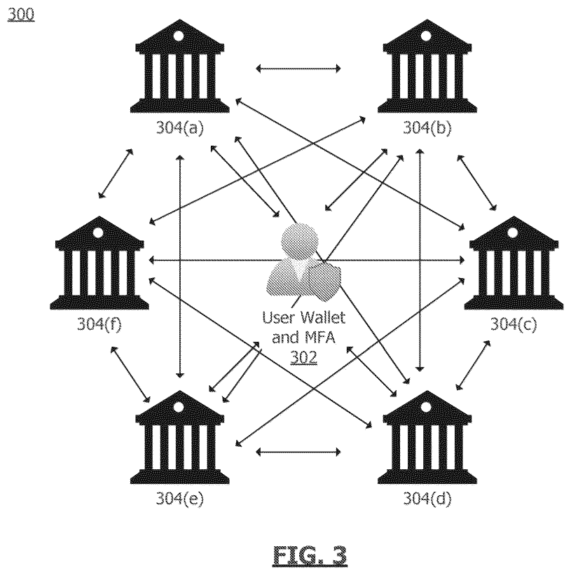

In some embodiments of the Platform, a user's digital wallet may also contain connectivity to a decentralized passphrase recovery system that works to fragment, hash, and store portions of passwords and keys in other devices. Portions of passwords and keys may be stored, for example, in a banking core or other trusted devices identified by the user. In this example embodiment, a user may recover a password from a set of trusted entities in case of a lost password. Using a combination of multifactor authentication (MFA) enablements, some of which may be provided by a credentialing platform/server and/or KYC platforms, the user can supply the required MFA components to the network to reconstitute keys. An example architecture of this example is similar in form and function to mesh topology coupled with RAID array storage mechanisms illustrated by FIG. 3. In FIG. 3, network diagram 300 illustrates a user wallet 302 connected to a plurality of trusted entities 304(a)-304(f).

A digital wallet passphrase is a security measure used to protect access to cryptocurrency funds stored in a digital wallet. It typically consists of a sequence of words or characters chosen by the wallet owner, serving as a form of encryption key. This passphrase is used to encrypt the private keys associated with the wallet, making it essential for accessing and managing the funds within. By requiring the passphrase to decrypt the private keys, digital wallets ensure that only authorized individuals can access and control the cryptocurrency stored in the wallet, adding an additional layer of security against unauthorized access and theft.

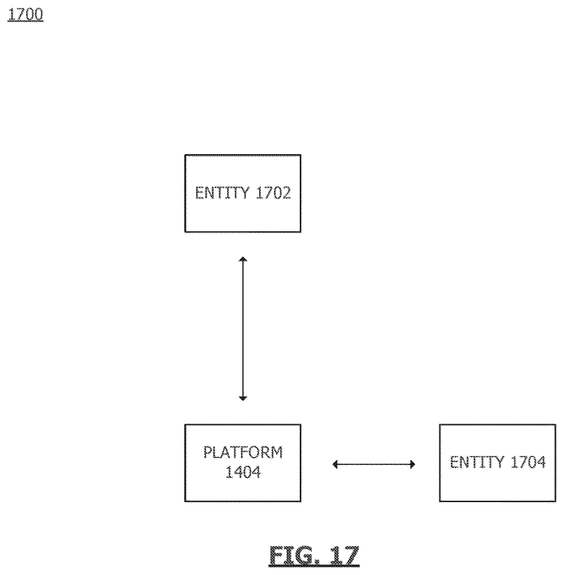

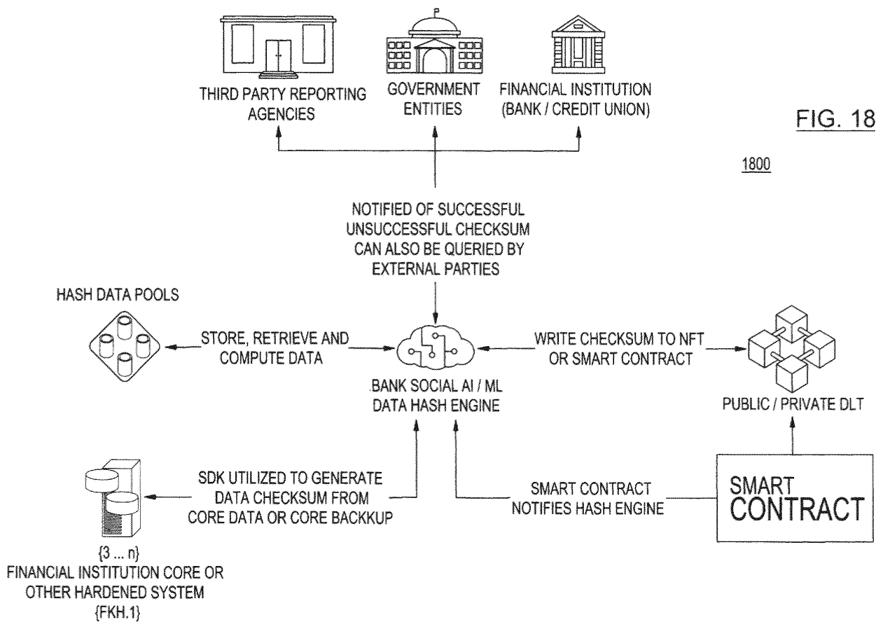

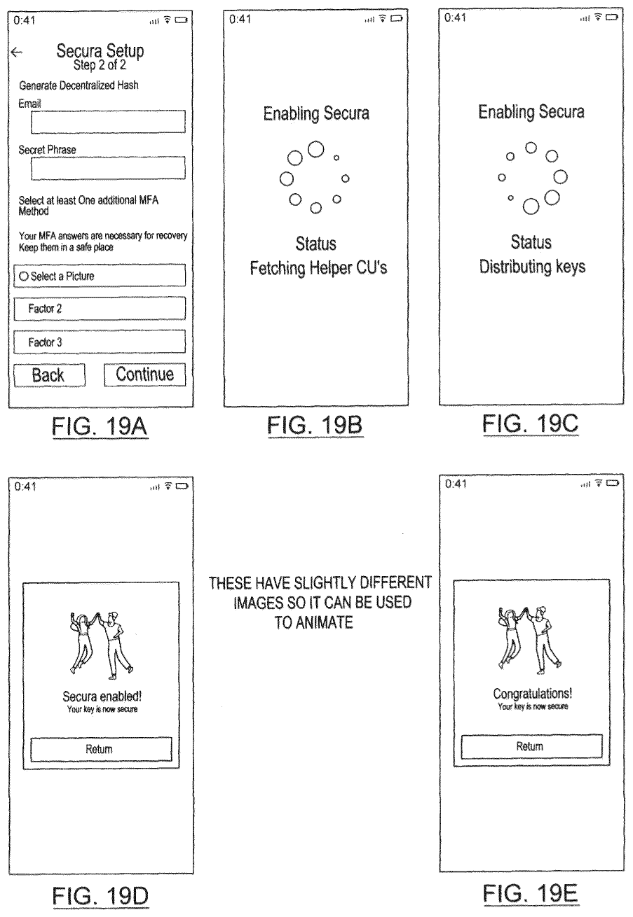

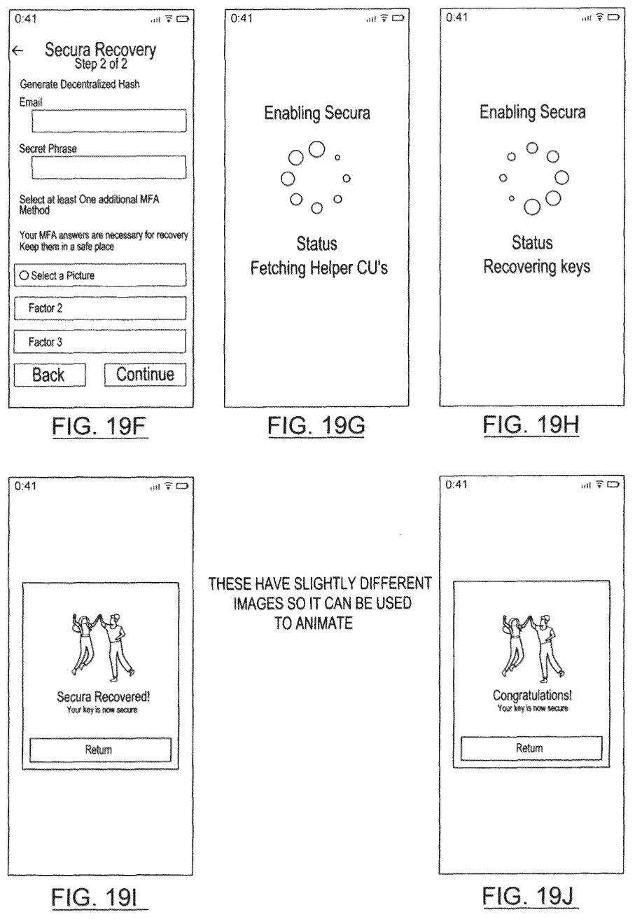

In some embodiments of the Platform, a user may perform a Wallet Passphrase (the “key”) Hot recovery process using a decentralized recovery mechanism. Referring to FIG. 4 and FIGS. 19A-19E, hot recovery may be performed using, for example, mobile device 406, user wallet 302, and institution 304. Institution 304 may be a single trusted entity or multiple trusted entities, such as the multiple entities illustrated by FIG. 3 and as described herein. To begin the distribution process, a user opens their digital wallet app on their mobile device 406. If the user has not distributed their Wallet Passphrase (“key”) through the decentralized recovery mechanism, they may be presented, via an interface in the app, an opportunity to start the key distribution process. For example, the user may tap on an icon or button displayed by the interface to distribute their key. In one example, the app may algorithmically break the key into many pieces using an existing or novel secret sharing algorithm and then would encrypt the pieces with a hash of user defined multi-factors which could be passwords, such as PII (e.g., name, social security numbers) or any other set of information known to the user (the “hash key”). The hash key may be used as the key for looking up the pieces of the user's key, as defined in the recovery process. The app may then query an API, such as AI/ML Engine 410 to randomly select N number of Institution (the “helper”) storage locations (the “appliances”), such as N number of locations 304(a)-304(f). The app may then distribute the encrypted key fragments and hash keys to the random helper appliances. The helper appliances may salt (i.e. add a unique and randomly generated sequence of characters) the hash keys to prevent lookups for the same keys across helper appliances. The user may then receive feedback from all N helpers that the pieces of the key are secured. If a helper does not return a response, a new random helper is selected and the remaining key fragment is sent to that helper appliance. This process repeats as necessary until all key fragment pieces are distributed.

### Hot Recovery—Recovery Process

In some embodiments, a user may need to recover a lost key for many reasons, including but not limited to, lost passphrase, destroyed phone, unrecoverable wallet/passphrase, etc. Upon entering the app, the user may be identified with their username and password, and if they have a subscription, they may be presented with the opportunity to recover their key. In some embodiments, if the user does not log in, they can always manually start the recovery process. FIGS. 19F-19J illustrate passphrase recovery interfaces that may be displayed by the user's device, such as on device 406 of FIG. 4.

To recover their key, the user may be presented with multi-factors that were used during sign up. The user fills out the multi-factors to recreate the hash key. The hash key may then be distributed to the entire network of helper appliances to do a lookup. The helper appliances add their salt to the hash key and locate the key piece then report back to the app with the key piece. The app awaits for the minimum number of key pieces Y of N total pieces and reconstitutes the entire key with the secret sharing algorithm. The app then reconstitutes the wallets associated to the keys.

Wallet Passphrase (the “key”) Cold Recovery

In some embodiments, a user may perform a Wallet Passphrase (the “key”) Cold recovery process using a decentralized recovery mechanism. While hot recovery refers to a process of regaining access to a digital wallet using a passphrase that is stored online, as described above, cold recovery refers to a process of regaining using access using a passphrase that is stored offline. Referring to FIG. 4, cold recovery may be performed using, for example, mobile device 406, user wallet 302, and institution 304. Institution 304 may be a single trusted entity or multiple trusted entities, such as the multiple entities illustrated by FIG. 3 and as described herein. A user may, similar to the hot recovery process, setup the app on their phone to distribute their key. However, in doing so, the user may use a government issued identity number or any number as deemed by the user as a component of their multi-factors (the “MFAs”). The user may also have the option to have other wallets and users sign as Power of Attorney wallets that can be used in the recovery process. In addition to the user MFAs, additional keys may be used to create the hash key and encrypt the payload. Additional keys may include, for example, a Credit Union key or a Platform key. The key pieces may then be distributed to the helper appliances. The user will also be presented with legal documents such as POD (“proof of death”), POA (Power of Attorney) and beneficiary documents that can be printed or sent to other people. These documents may, for example, be used to expedite the recovery process.

### Cold Recovery-Recovery Process

A user, like hot recovery, may need to recover for several reasons, additionally, the user may have a situation that renders them incapacitated and would require a 3rd party to be a part of the recovery process. A user may initiate a cold recovery from the app by entering the government issued identity number or number used to initiate the initial cold recovery distribution. If they were given the POA, POD or beneficiary legal documents, they could scan the QR code on those documents to initiate a cold recovery. In some embodiments, the user may be geolocated by the app and two financial institutions would be chosen at random and presented to the user. The system may generate two sets of documents to be taken to the financial institutions for notary. If the user has the original document from the distribution process, those may be used in the notary process. Once notarized, the user may then upload the completed documents to the app. The Platform team and Credit Unions would then use their key in conjunction with the user number to recover the key and reconstitute it on the app. The hash key may then be distributed to the entire network of helper appliances to do a lookup. The helper appliances add their salt to the hash key and locate the key piece then report back to the app with the key piece. The app awaits for the minimum number of key pieces Y of N total pieces and reconstitutes the entire key with the secret sharing algorithm. The app then reconstitutes the wallets associated to the keys.

In some embodiments, an AI/ML engine may determine the best path for eliminating key attack vectors and unique key distributions. The AI/ML engine may, for example, make the determination through a combination of pattern recognition on the network, known distributions of other vital fragments, and using known patterns in key fragment distribution to pick the nodes with the least amount of critical fragments in descending order. The AI/ML engine can then use a randomized algorithm to distribute the fragments amongst the least used nodes randomly. Once the order and fragment locations are determined, the AI/ML engine may call the appropriate hardened systems through an API or via direct integrations to distribute the key fragments.

In one non-limiting example, in view of the example diagram 400 of FIG. 4, a user 302 may walk into an institution 304, such as a credit union, which provides a digital ATM or kiosk to perform one or more actions from a remote digital device 406 (e.g., mobile device or other computing device). The user's device 406 may be used to enable the host with a portion of their fragmented key. The user 302 may provide one or more MFA components, such as biometrical data or the like. Institution 304 may perform an enhanced MFA process directly with the user's device 406. Additionally, the user's device 406 may be used to engage the MFA components to hash and manage the fragmented keys to trusted intermediaries 410 with the support of AI/ML engine 408. AI/ML engine 408 may, in some cases, randomize and distribute key fragments amongst a plurality of trusted intermediaries, such as the plurality of trusted entities 304(a)-304(f) of FIG. 3. In this example, no single intermediary can reconstitute a key without most trusted intermediaries coming together to reconstitute the entire key.

Continuing with the above example, an AI/ML engine may determine the best path for eliminating key attack vectors and unique key distributions. The AI/ML engine may, for example, make the determination through a combination of pattern recognition on the network, known distributions of other vital fragments, and using known patterns in key fragment distribution to pick the nodes with the least amount of critical fragments in descending order. The AI/ML engine can then use a randomized algorithm to distribute the fragments amongst the least used nodes randomly. Once the order and fragment locations are determined, the AI/ML engine may call the appropriate hardened systems through an API or via direct integrations to distribute the key fragments.

In one non-limiting example, in view of the example diagram 400 of FIG. 4, a user 302 may walk into an institution 404, such as a credit union, which provides a digital ATM or kiosk to perform one or more actions from a remote digital device 406 (e.g., mobile device or other computing device). The user's device 406 may be used to enable the host with a portion of their fragmented key. The user 302 may provide one or more MFA components, such as biometrical data or the like. Institution 404 may perform an enhanced MFA process directly with the user's device 406. Additionally, the user's device 406 may be used to engage the MFA components to hash and manage the fragmented keys to trusted intermediaries 410 with the support of AI/ML engine 408. AI/ML engine 408 may, in some cases, randomize and distribute key fragments amongst a plurality of trusted intermediaries, such as the plurality of trusted entities 304(a)-304(f) of FIG. 3. In this example, no single intermediary can reconstitute a key without most trusted intermediaries coming together to reconstitute the entire key.

In some embodiments of the disclosed technology, the Platform may use various forms of deterministic and heuristic optimization to identify selling and trading patterns and optimize those types of transactions. Over time, the Platform may suggest, assist, and with the user's authorization, automatically convert digital assets to other digital assets or from digital asset formats to stablecoin, fiat, or any combination thereof. The digital assets, in any form, could then be used in e-commerce transactions. In one example, as shown in FIG. 5, an AI/ML engine 408 may be used for conversion of tokenized assets, like homes 510(a), cars 510(b) and securities 510(e), cryptocurrency 510(c), fiat currency 510(d), bank cards 510(e), other assets 510(f), or combinations thereof. Conversions to fiat currency may include traditional rail mechanisms, such as ACH, FedNow®, Zelle®, or the like. In one example, at the time of a purchase 502 or sale 506, the AI/ML engine 408 may be used to either spend from fiat deposits in conventional bank accounts or other centralized systems while at the same time potentially using funds in the user's digital wallet 302 to immediately convert and transfer a digital asset to a merchant that is accepted by the merchant, such as a digital asset, a stablecoin, a fiat currently, or some combination thereof.

In some embodiments, the user can use physical cards such as a debit/credit card, digital credit card, or another type of payment instrument (e.g., Apple Pay®). The user would swipe/tap the physical card and the AI/ML engine 408 may automatically determine the best asset or assets 510 to liquidate in whole or in part, immediately to settle the transaction. In one example, during a purchase, the user's digital wallet 302 may determine if the user has enough of a certain digital asset (e.g., stablecoin) to be transacted on a public or private distributed ledger (DLT) and potentially bypass other traditional rails like ACH or Zelle®. Alternatively, the user's digital wallet 302 may complete a transaction using a combination of private/public DLT and traditional rails.

In some embodiments of the disclosed Platform, a user, via an interface of the digital wallet application on their device, may instruct an AI/ML engine to generate various levels and techniques of risk profiling and modeling. For example, the user may opt for more conservative or aggressive trading patterns automatically. Additionally, or alternatively, the Platform, using the AI/ML engine, may suggest transactions to the user, such as account transfers or account rebalancing of digital assets, fiat, or a combination of all assets in the user's portfolio and displayed via the user's digital wallet application on their device. In some cases, the user may select an appropriate risk profile or instruct the AI/ML engine to determine a risk pattern based on their prior activities and/or behavior. The AI/ML engine may then automatically rebalance the user's portfolio from digital, fiat, and other assets to achieve the desired or computed risk profile. Additionally, the AI/ML engine may allow the user to dollar cost average based on the selected or derived risk profile. Further, the AI/ML engine may also facilitate intelligent contract interaction by employing one or more of the following:
Interaction with the user's digital wallet and determine if one or more predefined decentralized financing staking opportunities fit the user's selected or AI-determined risk profile. The AI/ML engine may move the user's fiat, digital assets, or other assets in and out of intelligent contract staking opportunities.
Decentralized exchanges.
AI lending and borrowing.
Allowing users to stake their digital assets with other metadata and attributes that can be ascribed with a value that allows them to be borrowed or collateralized against other transactions to derive value that could then be converted and used as another digital asset.

In some embodiments, a user may stake an asset, or a portion of an asset, such as a home, car, or another tangible item that can be borrowed against that other users can pay for, thereby freeing up capital that then can then be used to pay at the point of sale with real-time liquidity or to be used to stake or purchase other digital assets.

### User and Document Verification System

In some embodiments of the disclosed technology, the integrated distributed ledger ecosystem and operating platform (the “Platform”) may provide a user and/or document verification system. The verification system may be a combination of centralized and decentralized AI, machine learning, and manual user and document verification systems frontends and backends, the workflow of which may be customized based on the needs of those performing verification. In one example, the verification system may function as part of a digital wallet application described herein, as an app on a user's device, as a third-party app embedded widget, or as an API that can be used with other systems and techniques to verify biometric features. Biometric features may include, for example, facial, skin, retinal, voice, and other attributes generally classified as biometric data. Additionally, biometric features may include user-supplied documents, to match biometric features with documents supplied by the customer, business, or any entity that may be available through other third-party integrations.

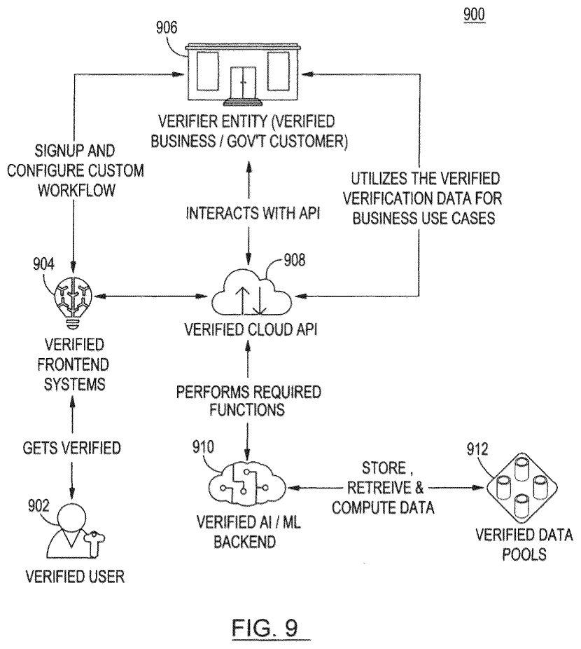

Using a combination of a deep learning Convolutional Neural Network, k-Nearest Neighbors (KNN) algorithms, Optical Character Recognition (OCR) algorithms, and/or other algorithms used in deep learning and AI, the document verification system may deterministically identify and categorize users and their documents. Such capabilities reduce and eliminate fraud. Additionally, the document verification system may be used as the basis for a Single Sign On (SSO) system that can enable any B2B, B2C, and P2P use cases, where Knowing Your Counterparty (KYC) is critical to ensuring components of a trade, transaction, or interaction are safe and secure. As shown in FIG. 9, users 902, businesses 906, and other entities may be funneled through a customizable workflow to capture information for the verification system.

In one example, once entity data is captured, a combination of AI, machine learning, and backend system users may validate the entity data and provide a risk score based on underlying documents and biometric data and its proximity match to verified documents and biometrics. The verification system may use a verified AI/ML backend 910 to use CLA, other AI/ML algorithms and heuristics, SDR, or other data modeling techniques to predict the entity's biometrics and data documents. The AI/ML backend 910 may use prior art or take facial data from a document provided, for example, and compare the vertices on the documents with the photos and real-time facial vertices to detect anomalies between the two and deep fake inconsistencies around the hairline, jawline, and necklines. The AI/ML backend 910 may also call out to a verified third-party entity 906, like a governmental entity via a verified cloud API 908 to obtain authorized and known facial, thumb, voice, or other biometric data to compare in real time. Further, the AI/ML backend 910 may also scan with prior art OCR and determine if documents scanned and provided by user 902 are valid. In some embodiments, user 902 may interact with the verification system via a frontend system 904. Additionally, an interface may be provided on the user's device to interact with frontend system 904.

Once the AI/ML backend 910 determines that a person's facial biometrics match their real-time biometrics, along with all the documents being valid, the system may then make API calls using the user's identifying data (e.g., social security number) to pull questions and answers from data reporting agencies, such as Experian®, Equifax®, Transunion®, or the like. The additional data obtained from the data reporting agencies may be added to a verification matrix for the user. The questions may then be presented to the user for verification. If the user fails the verification questions or biometric comparison, the user's verification may be rejected. When rejected, the user may be prompted to try again, such as via email or a notification within an app. If the user passes the verification questions, biometric comparison, or both, the user's data, including primary biometric data, credit check, and other data, such as on-chain transactions, may be stored on a database, such as verified data pools 912.

In some embodiments, a software development kit (SDK) may be used whereby required data and optional data may be passed into the SDK. The SDK may create a checksum hash of the data. The SDK may then log the checksum to a public ledger and an NFT may become the user's credential. A third party may then use the SDK or the checksum algorithm that is provided by the user verification system. The third party may validate that a user checksum matched their data, query an API of the system, such as API 908, for specific data elements and ask the API if a user checksum was valid. The risk score may then be used in creating a deterministic user profile. The risk score and feedback may be presented in many forms, including web and app versions and through email, and may be queried through an API. In an embodiment wherein an API is chosen as the medium for supplying the verification system, an approved third-party verifier may configure the necessary workflow in their backend, then write the frontend user interface, such as frontend 904, in whatever format they selected including but not limited to apps, websites, or other APIs. Additionally, a verifier may be issued a token that can be used later to retrieve a verification, continue a partially completed verification, or invalidate a prior verification.

### User Credentialing Platform

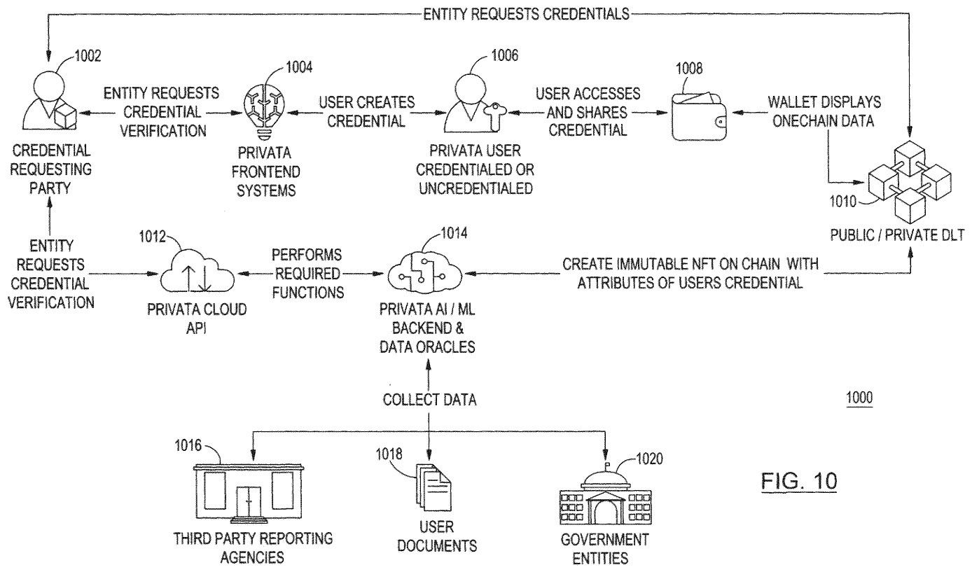

In some embodiments of the disclosed technology, the integrated distributed ledger ecosystem and operating platform (the “Platform”) may include a credentialing system. The credentialing system, as illustrated by example flow 1000 of FIG. 10, may be a standalone credentialing platform that allows users 1006, businesses, and governments to use DLT 1010 to distribute credentialing data and use public and private ledger cryptography. The credentialing system may be used to authenticate and credential aspects of a user's or business entity's attributes that would be typically used to verify, authenticate, gate, authorize, or enable the use or participation in a system or activity that would otherwise not be possible without a verified credential. The credentialing system and methods may be provided through an extension of the verification system described herein.

An entity's credential may be comprised of many components of a one-to-one (key/value) or many-to-many entity relationship. The entity's credential may be stored in the form of a non-fungible token (NFT) on a public or private distributed ledger, such as DLT 1010, that has the capability and capacity to store data sets on a blockchain. The format of those data can be plain text, such as the JSON ERC-721 or ERC-1155 standard JSON payload for NFTs, or encrypted data that can be encrypted by some other system to be stored on a chain for decryption by another system or entity, or it can also be a hash of a data point off a chain that can be used to validate the integrity of off-chain data with the on-chain hash. The credential may be associated with a public cryptographic wallet address for a digital wallet 1008 on a public or private ledger. The credentialing platform may use an AI/ML backend 1014 to identify patterns or behaviors in user behavior to be used as a basis for alerting and monitoring the user or credential providers of unexpected or illicit behavior. Additionally, algorithms, such as CLA and other algorithms deemed appropriate for AI and machine learning, may be used by the AI/ML backend 1014.

In some embodiments, behavior patterning may be derived from sparsely distributed representation models of dimensional data cube aggregations illustrated by FIGS. 8A and 8B. An entity's credential may be tied to one or more digital wallet public addresses on public and private ledgers, smart contracts, or other on-chain assets in a leveraged or custodial state. Base credentials may be enhanced with new credential enablements that are layered or combined with the original credential to create a more robust credential.

As part of flow diagram 1000 of FIG. 10, a user 1006 signs up for a service, such as the Platform described herein, and must present a credential for access or consideration to use the service. If they do not already have a credential, they may go through a verification service, such as the verification system described in FIG. 9 using frontend 904 via frontend 1004. Frontend 904 may act as an oracle to gather data required for a specific use case. Once the data is gathered from the user and third parties, including but not limited to credit reporting agencies, government agencies, third-party loan servicers, financial institutions, and documents like government-issued ID/passport/Social Security/Birth certificates, the data may be encoded via a hashing mechanism like SHA-256 to securely store and transport data on a public or private ledger. In addition, the credential created may be used to monitor liquidity of tokens in the user's wallet and depending on the liquidity available at an exchange may qualify the value of an asset ((tokens in the liquidity pool of that exchange*100)/tokens outstanding) (“Liquidity calc”) to get a ratio of the strength of the liquidity, or by querying a DEX or exchange price aggregator like CoinMarketCap, and matching the liquidity positions in the user's wallet and log that to the credential using the liquidity calc equation above.

The user may connect and present their credentials to a requesting party 1002 via a digital device. For example, user 1006 may present their credentials to requesting party 1002 via their digital wallet 1008. The requesting party may then use the credential to ensure that the credential is valid and contains the proper attributes that meet the threshold for access to a requesting party's product or service. Requesting party 1002 may request credential verification from backend 1014 via an API, such as cloud API 1012.

In some embodiments, the credentialing service may use any single component or a combination of a valid hash signature, an API call to a credentialing oracle, or a reviewing of the data contained within the user's credential, to determine whether to allow access or grant whatever the credential is meant to bestow in the reviewers' ecosystem. The user's credential may be tied to an on-chain asset such as an NFT, smart contract, or public/private wallet address by way of the credentials hash that would keep the user's information private but would also allow for a tie back to the original credential.

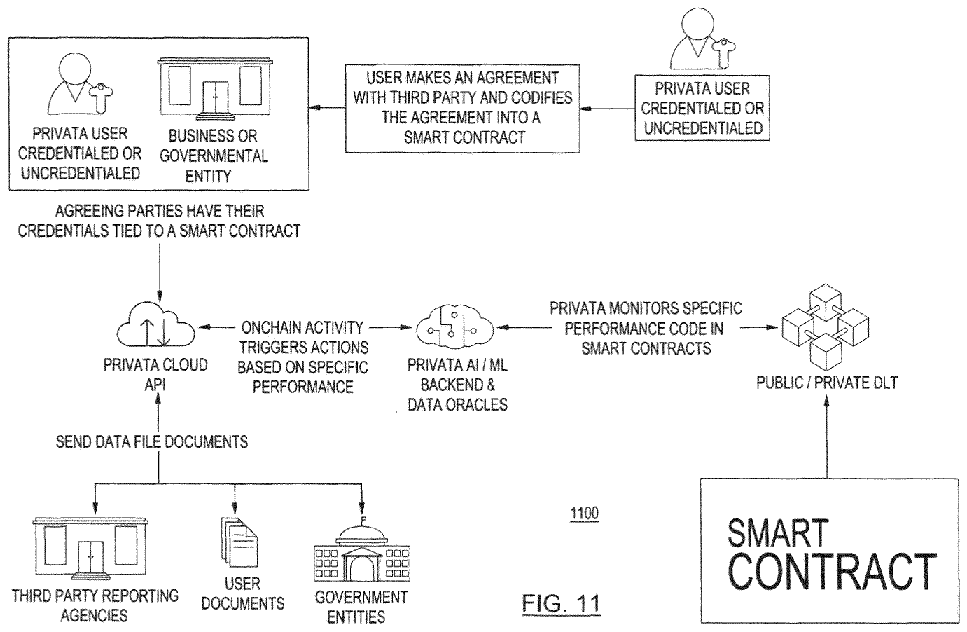

When a user's credential is tied to a smart contract, the smart contract may be used as a mechanism to monitor the specific performance of a legal contract between two entities and can perform various actions based on the adherence or lack of performance based on the terms of the smart contract. FIG. 11 illustrates a flow diagram 1100 of a user's credential being tied to a smart contract. If the terms of the smart contract are adhered to, the smart contract will continue to function as an escrow agent or arbiter to monitor and ensure that specific performance is followed. In the event of a breach of the terms of the smart contract, the smart contract, using the information in the credential and the information contained within the associated asset(s), could, on behalf of all represented parties, file claims via an AI mechanism to repossess, cloud on title, encumbrance, or lien applications with a direct filing at the appropriate governing entity.

In some embodiments, the AI mechanism may use CLA, other AI/ML algorithms and heuristics, SDR, or other data modeling techniques to create forward-looking and current state predictive models. Once a delinquency pattern is identified based on the risk modeling and contractual obligations set in the on-chain smart contract, the AI mechanism may use existing art to prepare the documents for filing. Those documents may be sent, for example, via email so that the appropriate party could manually file them or be automated to be filed automatically at the proper time and venue.

In some embodiments, the smart contract and credentialing oracle can also submit filings or notices on behalf of the parties and in line with the terms outlined in the contract. The notices or legal documents would, in addition to being filed traditionally, be filed on a public or private DLT so that the documents are cryptographically hashed and immune from forgery or loss. Once a document is filed on-chain it can be monitored, and other specific performances can be tied to the next steps or other specific performance.

In some embodiments, using the credential in conjunction with real time on-chain transaction monitoring ensures that users are not at risk of unauthorized access, that their wallet is not interacting with third parties known to have connections with nefarious wallets or systems, or that nefarious assets are not being commingled with clean and non-compromised assets.

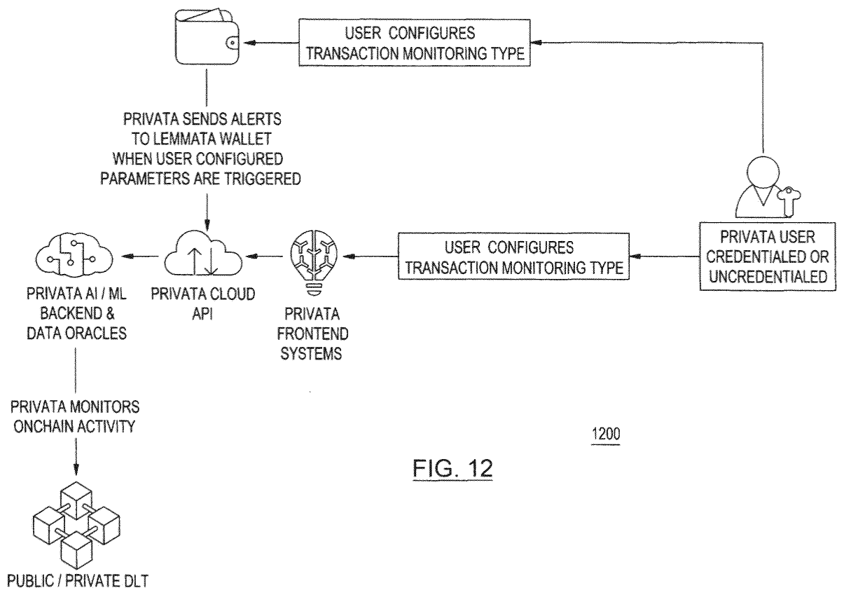

In some embodiments, as shown in FIG. 12, the AI mechanism may monitor wallets and on-chain assets tied to a user's credential. The AI mechanism may use the CLA and SDR to identify and predict patterns, create learning models, and distribute notices and information to parties requiring notice. For example, a user can pair their credential on-chain with an asset, wallet address, or smart contract by using their digital device and connecting the device through the credential platform's API or via their Digital Wallet to associate their credential with the asset. Once the asset is associated with the credential, the AI mechanism monitors and sends notices via an API endpoint socket, HTTPS connection, or other connections commonly used for transporting data. The AI mechanism can also send notices directly to the user's Digital Wallet. Further, the AI mechanism may also be permitted to take preventative action and lock down assets or wallets to mitigate attacks.

### Stablecoin Platform

A stablecoin is a type of cryptocurrency designed to maintain a stable value, often pegged to a fiat currency like the US dollar or a commodity like gold. Unlike other cryptocurrencies, which can experience significant price volatility, stablecoins aim to minimize fluctuations by backing their value with reserves or using algorithms to adjust the coin's supply based on demand. That stability makes stablecoins useful for transactions, hedging against volatility in other cryptocurrencies, and providing a reliable store of value in the crypto market.

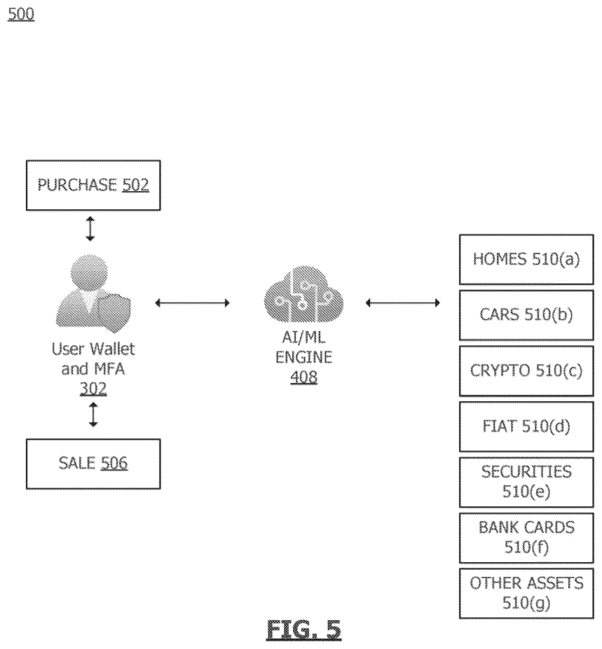

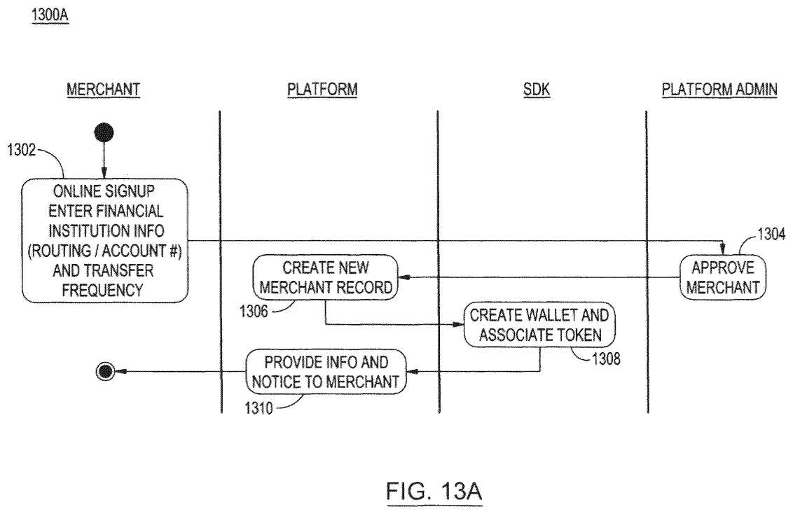

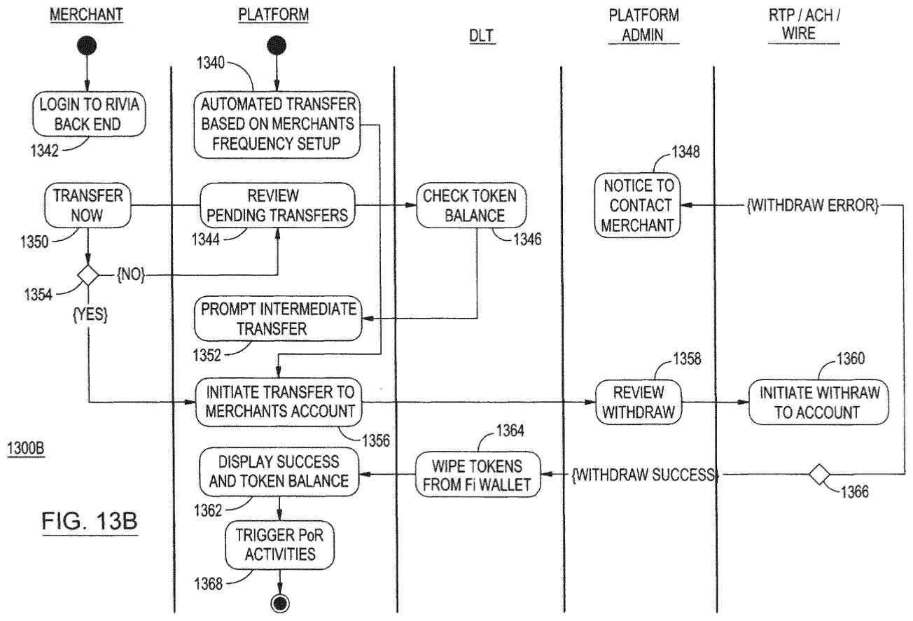

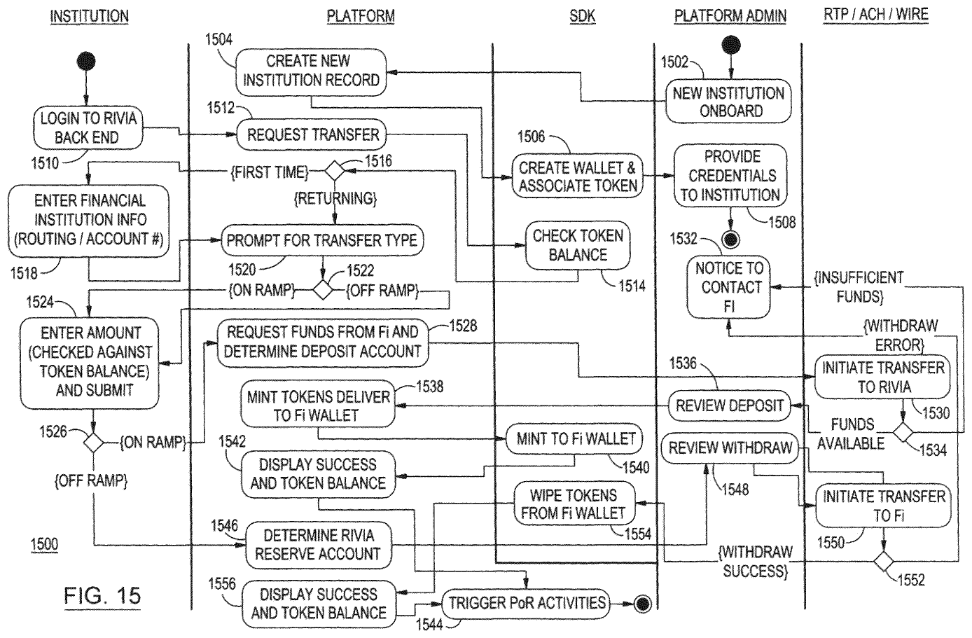

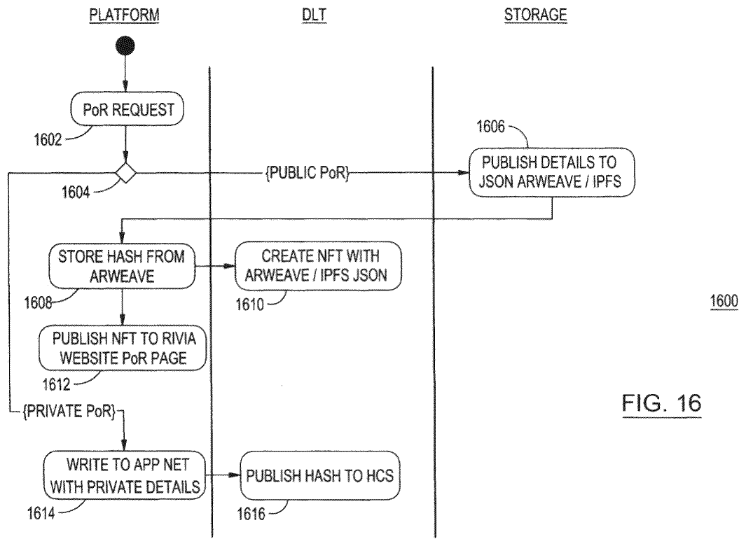

In some embodiments of the disclosed technology, the integrated distributed ledger ecosystem and operating platform (the “Platform”) may include, using distributed ledger technology (DLT), a stablecoin platform where the DLT issues one token to every one dollar in deposits. It achieves a one-to-one backed stablecoin that reduces the liquidity risk of over-leveraging the backing dollar to the minted token by utilizing a mesh topology to distribute liquidity amongst institutions, such as Credit Unions, Community banks, Federal Banks, and licensed, insured banking institutions worldwide. The stablecoin can be used to transact in various mechanisms including but not limited to replacing traditional payment mechanisms for merchants and B2B and B2C payments in combination with traditional payment rails for settlement. See FIGS. 13A and 13B. In addition, the token may be used in financial-to-financial settlements between institutions to reduce transaction time, cost, and risk (FIG. 15), both in a public or private ledger. Transactions may be hashed with a user's credentials to create a sovereign KYC/AML-compliant payment infrastructure. To reduce risks associated with a single or a small number of depository institutions holding all the stablecoin reserve deposits, the mesh liquidity distribution method (FIG. 6) that incorporates a public/private proof of reserve mechanism (FIG. 16) distributes liquidity across “N” institutions. For example, liquidity may be distributed across one or more institutions 602(a)-602(g) of FIG. 6. That process may use an asset stability modeling formula based on a net worth ratio (Total Capital/Total Assets) with a 7% minimum threshold for soundness that can be adjusted based on parameters that include but are not limited to market conditions, regulatory requirements, institutional needs, and company needs, that takes into account asset holding size, deposits, and determines on how much liquidity can be held at any single institution. The token architecture also has an inherent processes that allows for the freezing of accounts, the wiping of balances from accounts, and the ability to set fees and increase or decrease supply based on the number of dollars being held in proof-of-reserve (POR) deposit accounts.

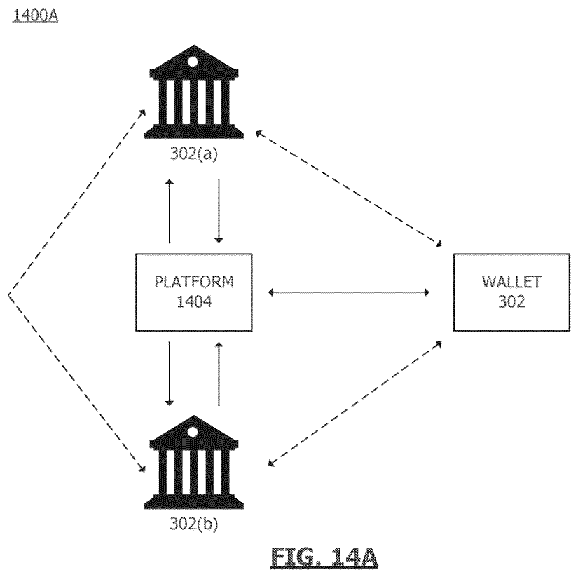

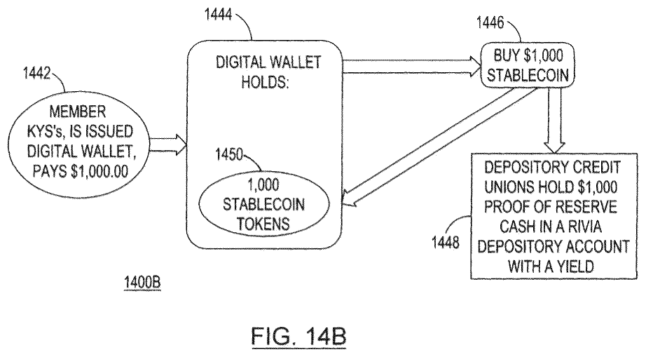

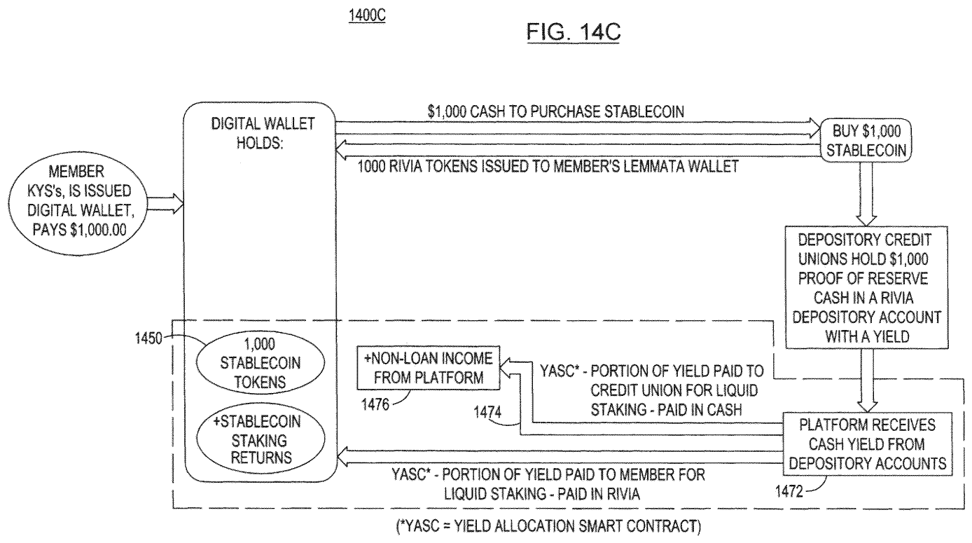

Referring to FIG. 14A, in one or more financial institution settlement embodiments, the financial institutions, such as 302(a) and 302(b), may create an account with the stablecoin platform 1404 to on-ramp and off-ramp fiat currencies into the stablecoin (e.g., $rUSD) token. Once the financial institution 302(a) has $rUSD tokens, the institution via a user's digital wallet 302, API, smart contract, app net, or any other method known by which a token/coin can be moved or transacted would use the transaction on a public or private distributed ledger to transact to finality within seconds. In preferred merchant services and payment gateway embodiments, merchants may sign up for a stablecoin platform account through the stablecoin platform's website or account to take stablecoin or Crypto payments through a merchant gateway such as Stripe®, Square®, or any other merchant services or gateway account. Upon enabling the stablecoin payment method, the stablecoin platform may bypass traditional payment card rails and perform a transaction on behalf of the customer and the merchant, thereby allowing the customer to send stablecoin directly to the customer account.

In some embodiments, as illustrated by FIG. 17, the stablecoin platform 1404 may act as a disintermediation between two settlement types, entity 1702 and 1704. For example, stablecoin platform 1404 can take a transaction from a traditional payment rail entity 1702, like Zelle® and settle with someone who wants to settle with another payment rail 1704, like FedNow®. That settlement process may use the mesh topology liquidity network of distributed liquidity across financial institutions.

In some embodiments, the stablecoin platform 1404 algorithmically and deterministically identifies a liquidity position at a financial institution 1702 with the requesting rail and systematically and programmatically settles with another financial institution 1704 in the liquidity network. The stablecoin platform can programmatically settle between any number of payment rails that are used in traditional finance. The stablecoin platform handles all the money movement since it has a dollar-for-dollar backing; there is never a change of a leveraged situation causing the requesting or settling parties or financial institutions backing the deposit to be at risk of a leveraged situation.

In some example financial institution settlement embodiments, the stablecoin platform can stabilize bank and credit union liquidity runs that are onset by bank runs. When users are concerned about a bank or credit union's financial stability, they typically make a digital transfer of money, leaving the source financial institution at risk of a bank run. Using the stablecoin platform's liquidity distribution (FIG. 6) and settlement disintermediation (FIG. 17), the stablecoin platform's systems can monitor outflows in real-time with AI using the CLA or other AI/ML algorithms and heuristics along with SDR or other data modeling techniques to create a forward-looking prediction of financial institutions with outflows that are at risk of falling below published requirements by government entities of asset balance thresholds that denote solvency. Once it was determined that a financial institution was at risk, the stablecoin platform's AI may use the settlement disintermediation mechanism and move liquidity through its settlement network to offset a portion of the outflow to maintain the balance of the underlying liquidity at all participating banks.

In some embodiments of the disclosed technology, the stablecoin described herein may be used as a settlement token. For example, as part of the Platform, the stablecoin may be used as a mechanism to directly on and off ramp a user directly into a distributed ledger token or coin from a fiat currency, fiat currency rail, or another coin or token, by way of the settlement disintermediation system.

The stablecoin may be used as part of a settlement transaction on the Platform, as illustrated by the following examples:
1) traditional financial settlement rail systems, like FedNOW®, Credit Cards, Zelle®, Venmo®, or any other money movement system with a programmatic interface that the Platform can programmatically connect to, such as an HTTP or Socket interface, and
2) a banking Core including, for example, Jack Henry®, Corelation®, Fiserv®, or any other Core banking software with a programmatic interface that the Platform can programmatically connect to, such as an HTTP or Socket interface.

Once the user accesses their digital banking application, mobile wallet, or digital wallet, the user may connect their bank account to the settlement disintermediation system using a bank account and routing number, username, password, phone, email or other mechanism as needed by the Core to authenticate, and their self-custody wallet addresses would also be associated with their account. In some embodiments, the settlement intermediation system may do a lookup against the banking Core to ensure the user had the proper credentials and was authenticated against the banking Core.

In one example, a user who is a member or customer at a Bank, Credit Union or other Financial Institution may be presented with one or more disclosures as part of a member/customer onboarding through an in-person interaction via a web or mobile interface or presented to an existing member during an in-person interaction via web or mobile interface. Via the interface, the user may select between funding and settlement endpoints with one of the endpoints being the ability to self-custody any token or coin (e.g., cryptocurrency) on any DLT (“Distributed Ledger Technology”). The user may first select a single, multiple or any combination of tokens/coins to receive as part of a fiat conversion through the settlement system. In addition, a user may choose to send any token/coin to any settlement rail system for payment or settlement to another bank account or accounting system used for settlement.

Once the user is authenticated in the Core, the settlement intermediation system will be able to intercept “Receive” transactions from settlement rails and route the funds via either the user's preferred coin/token or settlement to fiat currency in their bank account. When fiat currency When fiat currency is sent from an external settlement rail to a user's account, the settlement layer of the settlement intermediation system will recognize the receipt. Instead of moving fiat currency into the user's bank account, it may either mint stablecoin tokens or pull from a pool of already-minted stablecoin tokens, direct that fiat currency, and deposit it into a Proof of Reserve (POR) mesh liquidity distribution network of the financial institution's depository accounts (e.g., a Credit Union's Depository accounts). Once funds are moved from a settlement rail to a POR Depository account, stablecoin tokens corresponding 1:1 to the fiat currency may be placed in the Depository account and sent to the user's digital wallet (e.g., the user's self-custody wallet). The user's digital wallet may, for example, provide a user interface showing the user's balance of their depository account (e.g., fiat), digital currency (e.g., Stablecoin, $rUSD, $BTC, SETH), or the like.

In some embodiments, if the user chooses to receive any other token/coin besides stablecoin (e.g., $rUSD), the settlement layer may use an exchange, such as the BankSocial exchange described herein. Alternatively, any other exchange known to exchange digital assets may be used. The settlement layer may send the selected exchange $rUSD tokens in exchange for the Coin/Token the user has configured in their preferences. The $rUSD stablecoin token is merely being used as an example to illustrate implementation of the disclosed technology and is in no way meant to be limiting. Any stablecoin, or other cryptocurrency, may be used without departing from the spirit and scope of the disclosed embodiments.

A user may also configure a delayed conversion, whereby conversion is only done after the user is sent a text message, email, or other message to ask the user if they want their pre-configured token or another token sent to their self-custody wallet.

If the user does not respond within a set period (e.g., ten minutes, one hour, one day), the transaction automatically executes based on the user's default configurations, and the token/coin is sent as per the normal flow described above. Once a user has acquired any coins/tokens and has them in their self-custody wallet associated with their settlement account within the Core, they can also use those coins and tokens in real time as a payment method or send money via a settlement rail to another account. A user may identify an external account via a mechanism required by the settlement rail, including but not limited to account/routing numbers, emails, phone numbers, or usernames, as needed by a settlement rail.

After the user has selected and inputted the proper receiving person or institution, the settlement system may contact the appropriate settlement rail to confirm that the account exists on the other end. When the settlement system gets a positive response, the system will take the tokens/coins from the user's self-custody account and, depending on the coin/token type, will perform additional actions. If the token being sent is $rUSD, the settlement system will burn the token, move the money from the mesh liquidity distribution accounts and send the money to the settlement rail from the Proof of Reserve accounts. If the tokens being sent were any other tokens, the settlement system would contact an exchange via a programmatic interface, such as the BankSocial exchange, and would liquidate that coin/token for $rUSD coins or fiat, and would then proceed to send the funds to the settlement rail for final settlement. The system may remember prior sent and receipt transactions and have a log and list from which a user could select to make subsequent transactions faster. Additionally, or alternatively, the settlement system may automatically create an address book and use the user's mobile device to use contacts or wallet mechanisms as an interaction point.

In preferred financial settlement embodiments, a user may receive a payment from another person or business. The user will have configured their app, connected it with their account number, and created a new self-custody wallet. Once the sending party sends the funds, the receiving users' self-custody wallet will be updated with the amount of DLT tokens/coins that meet the conversion thresholds. In some embodiments, a user may receive a text message or an email notifying them of the pending receipt or funds and potentially notifying them of an exchange rate between the fiat and a token/coin. Additionally, this notification may be sent if there is not a direct 1:1 settlement with a stablecoin. The exchange may occur once the user accepts the exchange rate, and the token/coin will be issued to their self-custody wallet. Alternatively, the exchange may occur based on user-configured settings (e.g., accept exchange rate if within a certain range such as % or amount).

For example, a first user may select a first digital asset (e.g., $BTC) when receiving payment through the settlement disintermediation system. In this example, when a second user sends the first user a payment in a second digital asset (e.g., SETH), the settlement disintermediation system would first exchange the second digital asset for the first digital asset using a stablecoin (e.g., $rUSD). The settlement disintermediation system may complete the exchange by first exchanging the second digital asset for the stablecoin using one or more liquidity pools of the Platform described herein. The second digital asset would be exchanged for an equal amount in stablecoin (e.g., SETH for $rUSD). The settlement disintermediation system would then exchange an equal amount in stablecoin for the first digital asset (e.g., $rUSD for $BTC) using another one of the liquidity pools described herein. The second digital asset would then be sent to the first user. For example, to send the second digital asset, in this example $BTC, to the first user, a transaction containing the first user's address (e.g., wallet address), amount of $BTC and a digital signature is created. The transaction would be broadcasted to the Bitcoin network, where it is verified by nodes on the Bitcoin network. Once confirmed, the Bitcoin is transferred to the first user's wallet, such as the digital wallet described herein, recorded on the blockchain, and the transaction becomes irreversible. The digital wallet of the first user may be updated showing a result of the transaction completed when receiving $BTC from the settlement disintermediation system. The first user's digital wallet may show, for example, the status of the transaction (e.g., confirmed, pending), a blockchain hash, a link to view the transaction on the blockchain (e.g., Blockchain Explorer), or the like. The digital wallet of the second user may be updated as well, showing a result of the transaction completed when sending SETH to the settlement disintermediation system. The second user's digital wallet may show, for example, the status of the transaction (e.g., confirmed, pending), a blockchain hash, a link to view the transaction on the blockchain (e.g., Blockchain Explorer), or the like.

In another example, a first user may select a first digital asset (e.g., $BTC) when sending payment through the settlement disintermediation system to a second user. In this example, the first user may select a digital asset that is different from a payment type accepted or preferred by the second user. For example, the second user may accept payment in a second digital asset (e.g., $ETH) different from the first digital asset. In this example, the settlement disintermediation system would exchange the first digital asset for the second digital asset using a stablecoin (e.g., $rUSD). The settlement disintermediation system may complete the exchange by first exchanging the first digital asset for the stablecoin using one or more liquidity pools of the Platform described herein. The first digital asset would be exchanged for an equal amount in stablecoin (e.g., $BTC for $rUSD). The settlement disintermediation system would then exchange an equal amount in stablecoin for the second digital asset (e.g., $rUSD for $ETH) using another one of the liquidity pools described herein. The second digital asset would then be sent to the second user. For example, to send the second digital asset, in this example SETH, to the second user, a transaction containing the second user's address (e.g., wallet address), amount of $ETH and a digital signature is created. The transaction would be broadcasted to the Ethereum network, where it is verified by nodes on the Ethereum network. Once confirmed, the $ETH is transferred to the second user's wallet, such as the digital wallet described herein, recorded on the blockchain, and the transaction becomes irreversible. The first and second user's digital wallets may be updated accordingly as described above.

In some embodiments, users may send fiat payment to another third party. The user may first select from their self-custody wallet the token/coin they wish to use for payment. If the user selects rUSD, the rUSD token will be burned, and the fiat funds will be sent from the liquidity distribution network as fiat to the third-party awaiting payment. In other embodiments, the user may choose to send another coin/token, which would 1) be automatically sent to an exchange for conversion to rUSD, then 2) the rUSD would be burned, and a corresponding amount of fiat currency sent from the liquidity distribution network to the third-party awaiting payment.

The settlement platform also be used in the deployment of Smart contracts with “Liquid Staking” to generate yields equivalent to Money Market Deposit Accounts (“MMDA”). These rUSD are sent to a smart contract where the users' stake begins to earn a yield determined by the Platform, a third party, or a combination of entities, where the yield is based on the yield earned from deposits being held at Depository accounts at Credit Unions or banks. A portion of the yield earned may be shared with Liquid Staking users. These are typically relatively lower yields since users can remove their stake anytime. Smart contracts may be developed with “Locked Staking” to generate higher yields but with less immediate liquidity.

For example, a first user may select a first digital asset (e.g., $BTC) when receiving payment through the settlement disintermediation system. In this example, when a second user sends the first user a payment in a second digital asset (e.g., SETH), the settlement disintermediation system would first exchange the second digital asset for the first digital asset using a stablecoin (e.g., $rUSD). The settlement disintermediation system may complete the exchange by first exchanging the second digital asset for the stablecoin using one or more liquidity pools of the Platform described herein. The second digital asset would be exchanged for an equal amount in stablecoin (e.g., $ETH for $rUSD). The settlement disintermediation system would then exchange an equal amount in stablecoin for the first digital asset (e.g., $rUSD for $BTC) using another one of the liquidity pools described herein. The second digital asset would then be sent to the first user. For example, to send the second digital asset, in this example $BTC, to the first user, a transaction containing the first user's address (e.g., wallet address), amount of $BTC and a digital signature is created. The transaction would be broadcasted to the Bitcoin network, where it is verified by nodes on the Bitcoin network. Once confirmed, the Bitcoin is transferred to the first user's wallet, such as the digital wallet described herein, recorded on the blockchain, and the transaction becomes irreversible. The digital wallet of the first user may be updated showing a result of the transaction completed when receiving $BTC from the settlement disintermediation system. The first user's digital wallet may show, for example, the status of the transaction (e.g., confirmed, pending), a blockchain hash, a link to view the transaction on the blockchain (e.g., Blockchain Explorer), or the like. The digital wallet of the second user may be updated as well, showing a result of the transaction completed when sending SETH to the settlement disintermediation system. The second user's digital wallet may show, for example, the status of the transaction (e.g., confirmed, pending), a blockchain hash, a link to view the transaction on the blockchain (e.g., Blockchain Explorer), or the like.

In another example, a first user may select a first digital asset (e.g., $BTC) when sending payment through the settlement disintermediation system to a second user. In this example, the first user may select a digital asset that is different from a payment type accepted or preferred by the second user. For example, the second user may accept payment in a second digital asset (e.g., $ETH) different from the first digital asset. In this example, the settlement disintermediation system would exchange the first digital asset for the second digital asset using a stablecoin (e.g., $rUSD). The settlement disintermediation system may complete the exchange by first exchanging the first digital asset for the stablecoin using one or more liquidity pools of the Platform described herein. The first digital asset would be exchanged for an equal amount in stablecoin (e.g., $BTC for $rUSD). The settlement disintermediation system would then exchange an equal amount in stablecoin for the second digital asset (e.g., $rUSD for SETH) using another one of the liquidity pools described herein. The second digital asset would then be sent to the second user. For example, to send the second digital asset, in this example SETH, to the second user, a transaction containing the second user's address (e.g., wallet address), amount of $ETH and a digital signature is created. The transaction would be broadcasted to the Ethereum network, where it is verified by nodes on the Ethereum network. Once confirmed, the $ETH is transferred to the second user's wallet, such as the digital wallet described herein, recorded on the blockchain, and the transaction becomes irreversible. The first and second user's digital wallets may be updated accordingly as described above.

Referring to FIGS. 14B and 14C, flow diagrams 1400B and 1400C illustrate exemplary methods for the integration of a Stablecoin settlement token into a) digital banking frontend systems, core implementations, and using the Platform's digital wallet. In one example environment, this integration enables Parallel assets to be held by Members in a single wallet, including both Fiat Currency and Stablecoin assets. As shown in block 1442, a user, once verified, may be issued a digital wallet. The user may deposit $1,000 which the digital wallet holds 1444 and may be used to buy 1446 stablecoin with. In block 1448, a depository credit union, or other financial institution, may hold an equal amount (e.g., $1,000) Proof of Reserve cash in a Stablecoin Depository Account with a yield. The user's digital wallet may display 1450 the user's stablecoin balance. A yield to be generated 1472 to certain holders of the Platform by a “Yield Allocation Smart Contract” (“YASC”). This yield is available to Members who choose “Liquid Staking” within their Digital Wallet. A Yield may also to be generated 1476 for the participating Credit Union via a separate YASC between the Credit Union and the Platform. A Settlement Token must have specific unique characteristics to enable these capabilities, including, for example, 100% Proof of Reserve in fiat, 100% Liquidity on demand, and Yield Generation, in this case via Depository Agreements with participating Credit Unions, is sufficient to provide returns via YASCs to both Members and participating Credit Unions.

### Core Banking Data Hashing Platform

In some embodiments of the disclosed technology, the integrated distributed ledger ecosystem and operating platform (the “Platform”) may include a Core Banking Data Hashing (CBDH) platform. In some embodiments, in view of FIG. 18, a CBDH checksum mechanism may give banks, credit unions, and any financial institution utilizing a core banking system the ability to hash banking core data to public and private DLTs to provide transparency, immutability, and real-time monitoring to regulators, legislators, and the people. It may also be used to hash and checksum data from other third-party systems deemed necessary by a financial institution to be immutable and resistant or trackable for changes or unexpected manipulations.

For example, banking cores that already create system data backups do not currently provide immutability checkpoints built on public and private distributed ledgers. The described CBDH system may exist in several components. The first component is an SDK or software library, written in different computer languages, which may exist on the local servers, clouds, or machines where the banking core or third-party software (“core software”) is operational. The SDK would provide a checksum mechanism in which the core software, as they were taking a snapshot or a backup (“backups”), would call the SDK to create a checksum hash utilizing SHA256 or another hashing algorithm known to be resistant to reorg and indexing attacks. Once the backup checksum was created, the SDK would invoke the second component, an API, to make a call to the Platform servers passing the checksum.

Finally, a third component may be a combination of the disclosed CBDH systems and a private or public DLT, such as Hedera or Ethereum, whereby the checksum hash may be posted to the DLT, creating an indelible, immutable, mathematically verifiable checkpoint in time that ties a core system's backup to a public checksum of the backup. Utilizing these three components, auditors, internal to the bank and external to the bank, both in an automated fashion or manually, can query the public DLT to understand if core software is being backed up in a manner consistent with best practices and SLAs. In addition, it would allow auditors to review restored backups to ensure the backup was not manipulated or changed after a checksum of the backup was created. By comparing the public checksum, which remains indefinitely unchanged, to the checksum of the backups, which can be reconstituted using the SDK at any time, the auditor could determine whether data manipulation had occurred. Additionally, the system could be enhanced with smart contracts triggered upon successful or unsuccessful data hashing. The smart contract would have code embedded within the logic tree to identify attributes on the public or private chain and externally notify oracles or other APIs of data checkpoints.

In some embodiments, banking core or other third-party software could use the CBDH mechanism to create a checksum heartbeat to prove and provide immutable records and transparency for uptime. Using the CBDH mechanism illustrated in FIG. 18 and the example components described herein, uptime heartbeat checksums would allow third parties and government agencies to monitor uptime and SLAs.

In some embodiments of the disclosed Platform, Proof of Reserve (POR) of a bank or credit unions reserve requirement, call report (see Table 1), or other regulatory required data may be passed through the SDK checksummed and hashed onto a public ledger so that governments, third parties, and the public could monitor and evaluate in real-time the health of a financial institution. In addition to the checksum to certify the validity of the data, the CBDH software would submit regulator-required data, such as the call report, into the Platform's SDK. The SDK may take the data and create an NFT using a JSON payload and the ERC 1155 or 721 data structure.

The checksum would be associated to the NFT on-chain to the checksum and could tie back the data to the core banking system as well as the call data in the NFT as reported to the regulator. This POR mechanism can be combined with the POR concept for the Platform's stablecoin described above with respect to FIG. 16.

In some embodiments, checks use the CBDH mechanism for other data points in the core or third-party software as determined by a regulator, government official, financial institution, or third-party service provider. Using the mechanism in FIG. 18 and the three components described herein, data checksums for any data in the core would allow third parties to monitor uptime and SLAS.

In some embodiments, the three-=component system could be enhanced with a fourth component to provide more transparency around controlling when/how data hashing occurs within the core. This fourth component may partially reside in the SDK and the Platform systems. A financial institution may configure the ability to trigger a backup externally. Additionally, a user would use the Platform's interface to set the timing of backup requests. The Platform system may call the Platform's SDK connected to the financial institutions core and direct the core to make a backup and start the process described in the three-component system of creating checksum hash rollups for data and backups.

### Table 1:

### Reporting Requirements

The Call Report includes the quarterly financial statement and 9 schedules. All credit unions must complete the Statement of Financial Condition (Pages 1 through 3) and the Statement of Income and Expense (Pages 4 and 5) every reporting period. Schedules A through I require your input only as applicable.

The table below lists the schedules and applicable reporting requirements for each.

| SCHEDULE | REPORTING REQUIREMENT |
|---|---|
| A, Section 1 - Loans | Complete this schedule if your credit union |
| | has any loans. |
| A, Section 2 - Delinquent Loans | Complete this schedule if any outstanding |
| | loans are delinquent. |
| A, Section 3 - Charge-Offs/Recoveries | Complete this schedule if your credit union |
| | has any loan charge offs or recoveries. |
| A, Section 4 - Other Loan Information | Complete this schedule if your credit union |
| | has any loans to credit union officials, with |
| | interest rates that exceed 15%, purchased |
| | credit impaired loans, or purchased financial |
| | assets with credit deterioration. |
| A, Section 5 - Indirect Loans | Complete this schedule if your credit union |
| | has indirect loans outstanding. |
| A, Section 6 - Loans Purchased and Sold | Complete this schedule if your credit union |
| Under 701.22 and 701.23 | has purchased or sold whole or partial loans. |
| A, Section 7 - 1- to 4-Family Residential | Complete this schedule if your credit union |
| Real Estate Loans/Leases | has 1- to 4-family residential real estate |
| | loans. |
| A, Section 8 - Commercial | Complete this schedule if your credit union |
| | has commercial loans. |
| B, Section 1 - Supplemental Information | Complete this schedule if your credit union |
| for Available-for-Sale or Held-to-Maturity | has any investments classified as available- |
| Debt Securities | for-sale or held-to-maturity. |
| B, Section 2 - Supplemental Information | Complete this schedule if your credit union |
| for Trading Debt or Equity Securities | has investments classified as trading debt or |
| | equity securities. |
| B, Section 3 - Investment maturity | Complete this schedule if your credit union |
| distribution | has investments in time deposits or |
| | classified as available-for-sale, held-to- |
| | maturity, or trading. |
| B, Section 4 - Investment Memoranda | Complete this schedule if your credit union |
| | has non-conforming investments, brokered |
| | certificates of deposit, realized investment |
| | gains/losses, other than temporary |
| | impairment, assets used to fund employee |
| | benefit or deferred compensation plans, or |
| | charitable donation accounts. |
| C, Sections 1 through 5 - Liquidity | Complete this schedule if your credit union |
| | has unfunded commitments, off-balance |
| | sheet exposures, contingent liabilities, or |
| | borrowing arrangements. |
| D, Shares and Supplemental Information | Complete this schedule if your credit union |
| | has shares. |
| E, Supplemental Information | Complete this schedule if your credit union |
| | has grants, employees, plans to add any new |
| | branches, international remittances, money |
| | service businesses, or credit union service |
| | organizations. |
| F, Derivatives | Complete this schedule if your credit union |
| | uses derivative contracts. |
| G, Capital Adequacy | Complete this schedule if your credit union |
| | has completed a merger or acquisition that |
| | qualifies for business combination |
| | accounting, intends to use an optional total |
| | assets election to compute your net worth |
| | ratio, or has adopted Financial Accounting |
| | Standard Accounting Standards Codification |
| | Topic 326 - Financial Instruments - Credit |
| | Losses (CECL). |
| H, Complex Credit Union Leverage Ratio | Complete this schedule if your quarter-end |
| (CCULR) Calculation | assets exceed $500,000,000 and you are |
| | eligible, qualified, and electing to opt-in to |
| | CCULR. |
| I, Risk Based Capital (RBC) Ratio | Complete this schedule if your quarter-end |
| Calculation | assets exceed $500,000,000. |

As carbon offset capture and securitization starts to become part of ESG rollout and required aspects of critical infrastructure reporting and maintenance, a standardized way of quantifying, tokenizing, and creating an open mechanism of trade is required. Our novel carbon offset tokenization model and open exchange mechanism will facilitate this trackable open infrastructure of the future.

The carbon offset system would start with a user identifying the need to create a carbon offset NFT credit. The user would then enter into a user interface such as a website, command line interface, or API, the required data textual and document elements to quantify the source, type, location, amount, and any additional information that could be later identified. The data would then be encapsulated into a JSON payload following the ERC 1155 or ERC 712 payload spec for NFT JSON data. Utilizing key-value pairs within the JSON specification, data would be compiled into the JSON key-value pair to create a composite view of the carbon offset. If the carbon offset had other documents, such as PDFs, word docs, excel spreadsheets, or other non-string data elements, those would be stored on a traditional web server, or a distributed ledger meant for document storage as IPFS or Arweave. The document storage location would be associated with the NFT in the JSON payload in a manner consistent with 1155 or 721 specs. Once the NFT data was created, the NFT would be minted on a public or private DLT, and the appropriate JSON payload would be associated. That NFT would then be associated with the carbon offsetters wallet address and could be transferred to any other wallet address on any DLT. These carbon offsets could be liquidated in a Point of Sale transaction in real-time via the mechanisms described on page 5. The Carbon offsets could also be sold wholly or fractionalized by an offset owner who wishes to resell a credit. The fractionalization would happen via the BankSocial carbon token credits API or SDK, which any 3rd party could utilize in fractionalizing a carbon offset NFT to maintain the associated data elements required for qualifying the validity of a carbon offset credit.

### ADDITIONAL CONSIDERATIONS

According to some embodiments, a processor or a processing element may be trained using supervised machine learning and/or unsupervised machine learning. The machine learning may employ an artificial neural network, which, for example, may be a convolutional neural network, a recurrent neural network, a deep learning neural network, a reinforcement learning module or program, or a combined learning module or program that learns in two or more fields or areas of interest. Machine learning may involve identifying and recognizing patterns in existing data to facilitate making predictions for subsequent data. Models may be created based upon example inputs to make valid and reliable predictions for novel inputs.

According to certain embodiments, machine learning programs may be trained by inputting sample data sets or certain data into the programs, such as images, object statistics and information, historical estimates, and/or image/video/audio classification data. The machine learning programs may utilize deep learning algorithms that may be primarily focused on pattern recognition and may be trained after processing multiple examples. The machine learning programs may include Bayesian Program Learning (BPL), voice recognition and synthesis, image or object recognition, optical character recognition, and/or natural language processing. The machine learning programs may also include natural language processing, semantic analysis, automatic reasoning or other types of machine learning.

According to some embodiments, supervised machine learning techniques and/or unsupervised machine learning techniques may be used. In supervised machine learning, a processing element may be provided with example inputs and their associated outputs and may seek to discover a general rule that maps inputs to outputs, so that when subsequent novel inputs are provided the processing element may, based upon the discovered rule, accurately predict the correct output. In unsupervised machine learning, the processing element may need to find its own structure in unlabeled example inputs.

As will be appreciated based upon the foregoing specification, the above-described embodiments of the disclosure may be implemented using computer programming or engineering techniques including computer software, firmware, hardware or any combination or subset thereof. Any such resulting program, having computer-readable code, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps”, or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are examples only and are thus not intended to limit in any way the definition and/or meaning of the term “processor.”

As used herein, the terms “software” and “firmware” are interchangeable and include any computer program stored in memory for execution by a processor, including RAM memory, ROM memory, EPROM memory, EEPROM memory, and non-volatile RAM (NVRAM) memory. The above memory types are examples only and are thus not limiting as to the types of memory usable for storage of a computer program.

In one embodiment, a computer program is provided, and the program is embodied on a computer readable medium. In an example embodiment, the system is executed on a single computer system, without requiring a connection to a sever computer. In a further embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). The application is flexible and designed to run in various environments without compromising any major functionality. In some embodiments, the system may include multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

As used herein, an element or step recited in the singular and preceded by the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

The above discussion is meant to be illustrative of the principles and various embodiments of the present disclosure. Numerous variations and modifications will become apparent to those skilled in the art once the above disclosure is fully appreciated. It is intended that the following claims be interpreted to embrace all such variations and modifications.

What is claimed is:

1. A method for providing stablecoin settlement disintermediation, the method, with at least one computing device, comprising:
receiving verification of at least one user;
issuing an instance of a digital wallet to a digital wallet application on a mobile device associated with the at least one user;
receiving a transaction request from the digital wallet application;
completing the transaction request using one or more blockchain networks coupled to the stablecoin settlement disintermediation system.

2. The method of claim 1, wherein the instance of the digital wallet holds more than one digital currency in parallel.

3. The method of claim 1, wherein the digital wallet holds a first type of cryptocurrency associated with a first blockchain network and a second type of cryptocurrency associated with a second blockchain network.

4. The method of claim 1, wherein the transaction request includes a request to acquire one or more stablecoin tokens.

5. The method of claim 4, wherein the one or more stablecoin tokens are native to the stablecoin settlement disintermediation system.

6. The method of claim 4, wherein the one or more stablecoin tokens are used to complete transactions between the at least one user and another user connected to the stablecoin settlement disintermediation system.

7. A stablecoin settlement disintermediation system, comprising:
a processor;
at least one memory comprising instructions that when executed by the processor are configured to:
receive verification of at least one user;
issue an instance of a digital wallet to a digital wallet application on a mobile device associated with the at least one user;
receive a transaction request from the instance of the digital wallet;
complete the transaction request using one or more blockchain networks coupled to the stablecoin settlement disintermediation system.

8. The stablecoin settlement disintermediation system of claim 7, wherein the instance of the digital wallet holds more than one digital currency in parallel.

9. The stablecoin settlement disintermediation system of claim 7, wherein the digital wallet holds a first type of cryptocurrency associated with a first blockchain network and a second type of cryptocurrency associated with a second blockchain network.

10. The stablecoin settlement disintermediation system of claim 7, wherein the transaction request includes a request to acquire one or more stablecoin tokens.

11. The stablecoin settlement disintermediation system of claim 10, wherein the one or more stablecoin tokens are native to the stablecoin settlement disintermediation system.

12. The stablecoin settlement disintermediation system of claim 10, wherein the one or more stablecoin tokens are used to complete transactions between the at least one user and another user connected to the stablecoin settlement disintermediation system.

13. A method, comprising:
receiving verification of at least one user associated with a user device;
initializing a digital wallet on the user device;
receiving, from the digital wallet, an acquisition request of a digital asset, wherein the digital asset is associated with a settlement disintermediation platform;
creating a transaction based on the acquisition request;
sending the transaction to a blockchain network to complete the transaction; and
in response to the sending, updating the digital wallet based at least in part on information sent to the blockchain network to complete the transaction.

14. The method of claim 13, further comprising:
receiving, from the blockchain network, confirmation that the transaction has been confirmed; and
updating the digital wallet based at least in part on the received confirmation.

15. The method of claim 13, wherein the digital asset is a stablecoin.

16. The method of claim 15, wherein the stablecoin is used to complete transactions on the settlement disintermediation platform associated with the digital wallet.

17. The method of claim 13, wherein the settlement disintermediation platform is used to settle.

18. The method of claim 13, wherein the digital wallet holds more than one digital asset at a time in parallel.

19. The method of claim 13, further comprising:
intercepting, by the settlement disintermediation platform, a receive transaction for the user from a settlement rail; and
routing funds of the receive transaction by minting tokens of the stablecoin or pulling from a pool of already minted tokens of the stablecoin;
depositing funds of the receive transaction to a Proof of Reserve Depository account; and
sending stablecoin tokens corresponding 1:1 to funds deposited to the Proof of Reserve Depository account to the digital wallet.

20. The method of claim 13, wherein the stablecoin is 100% Proof of Reserve in fiat, 100% liquidity on demand, and generates yield based on one or more smart contracts created by the settlement disintermediation platform and executed by least one or more blockchain networks.
